(19) United States
(12) Patent Application Publication
(10) Pub. No.: US 2013/0220095 A1
(43) Pub. Date: Aug. 29, 2013

(54) CUTTER

(71) Applicants: Tetsuya Ukon, Settsu-shi (JP); Teruaki Tsuchiya, Settsu-shi (JP); Futoshi Okugawa, Settsu-shi (JP)

(72) Inventors: Tetsuya Ukon, Settsu-shi (JP); Teruaki Tsuchiya, Settsu-shi (JP); Futoshi Okugawa, Settsu-shi (JP)

(73) Assignee: DAIKIN INDUSTRIES, LTD., Osaka-shi, Osaka (JP)

(21) Appl. No.: 13/884,490

(22) PCT Filed: Nov. 28, 2011
(86) PCT No.: PCT/JP2011/006615

§ 371 Date: May 9, 2013

(30) Foreign Application Priority Data
Dec. 27, 2010 (JP) 2010-289254

(51) Int. Cl. H01H 39/00

(52) U.S. Cl. CPC H01H 39/006
USPC 83/639.1

(57) ABSTRACT

A release space (100) is formed in a holding member (47) so as to be disconnected from a back pressure chamber (49) before a blade member (30) cuts a current-carrying member (12), and communicate with the back pressure chamber (49) after the blade member (30) has cut the current-carrying member (12).

### TECHNICAL FIELD

The present invention relates to cutters configured to cut current-carrying members.

### BACKGROUND ART

Conventionally, cutters configured to cut current-carrying members through which current flows have been known. Cutters of this type are used to shut off power from a power supply, for example, in disaster situations.

PATENT DOCUMENT 1 describes a cutter configured to move a blade under the pressure of high-pressure gas generated in a gas generation chamber (back pressure chamber) to cut a current-carrying member. Specifically, the cutter includes a case member accommodating the blade such that the blade is movable. The current-carrying member is disposed toward the front of the blade, and the back pressure chamber is formed toward the back of the blade. The cutter includes a gas generator configured to generate high-pressure gas in the back pressure chamber. When the gas generator generates high-pressure gas in the back pressure chamber, the internal pressure of the back pressure chamber increases, and the blade moves forward. This movement allows the edge of the blade to be in contact with a target portion of the current-carrying member, and thus, the target portion is cut away. As a result, the current-carrying member is divided into two conductive portions, and the conductive portions are insulated from each other.

### CITATION LIST

### Patent Document

PATENT DOCUMENT 1: Japanese Patent Publication No. 2010-86653

### SUMMARY OF THE INVENTION

### Technical Problem

In a cutter of the above type, when a gas generator generates high-pressure gas in a back pressure chamber, the gas may leak toward a current-carrying member through, e.g., the gap between a blade and a case member. Therefore, after the current-carrying member has been cut, ambient air surrounding two conductive portions into which the current-carrying member has been divided may be filled with gas. When, as such, the two conductive portions are exposed to the generated gas, a discharge may be generated between the conductive portions through the generated gas. As a result, the insulating properties of the cut current-carrying member may be impaired.

It is therefore an object of the present invention to provide a cutter configured to ensure electrical insulation between portions into which a current-carrying member has been cut.

### Solution to the Problem

A first aspect of the invention is directed to a cutter, and the cutter includes: a blade member (30) configured to cut a target portion (40) of a current-carrying member (12); a holding member (47) formed in a cylindrical configuration to accommodate the blade member (30) such that the blade member (30) is movable, having one axial end having an opening (48) exposing the target portion (40), and the other axial end at which a back pressure chamber (49) is defined to face the blade member (30); and a gas generator (35) configured to generate high-pressure gas used to move the blade member (30) toward the target portion (40) in the back pressure chamber (49). A release space (100) is formed in the holding member (47) so as to be disconnected from the back pressure chamber (49) before the blade member (30) cuts the current-carrying member (12), and communicate with the back pressure chamber (49) after the blade member (30) has cut the current-carrying member (12).

According to the first aspect of the invention, the back pressure chamber (49) is filled with high-pressure gas generated by the gas generator (35). This increases the pressure of the back pressure chamber (49), and the blade member (30) axially moves through the holding member (47). The blade member (30) is in contact with the target portion (40) of the current-carrying member (12) through the opening (48) of the holding member (47), and allows a shearing force to act on the target portion (40). As a result, the target portion (40) is cut away, and the current-carrying member (12) is divided.

The release space (100) is formed in the holding member (47) of the present invention. The release space (100) is disconnected from the back pressure chamber (49) before the blade member (30) cuts the current-carrying member (12). This can ensure an increase in the pressure of the back pressure chamber (49) with the generation of high-pressure gas.

By contrast, after high-pressure gas has been generated, and the blade member (30) has cut the current-carrying member (12), the back pressure chamber (49) and the release space (100) communicate with each other. Thus, the high-pressure gas generated in the back pressure chamber (49) can be fed to the release space (100). Furthermore, communication between the back pressure chamber (49) and the release space (100) can reduce an increase in the pressure of the back pressure chamber (49). Thus, in the present invention, the high-pressure gas in the back pressure chamber (49) is prevented from leaking through, e.g., the gap between the holding member (47) and the blade member (30) to the vicinity of the target portion (40) of the current-carrying member (12).

According to a second aspect of the invention, in the first aspect of the invention, the release space may form an exhaust gas passage (100) through which after the blade member (30) has cut the current-carrying member (12), the back pressure chamber (49) communicates with a space outside the holding member (47).

According to the second aspect of the invention, the release space (100) of the holding member (47) forms the exhaust gas passage (100) for high-pressure gas. Specifically, after the blade member (30) has cut the current-carrying member (12), the back pressure chamber (49) communicates with the exhaust gas passage (100). Thus, the high-pressure gas flows out of the holding member (47) through the exhaust gas passage (100). As a result, the high-pressure gas in the back pressure chamber (49) can be rapidly released to the outside, and the internal pressure of the back pressure chamber (49) can be rapidly decreased. This prevents the high-pressure gas in the back pressure chamber (49) from leaking through, e.g., the gap between the holding member (47) and the blade member (30) to the vicinity of the target portion (40) of the current-carrying member (12).

According to a third aspect of the invention, in the first or second aspect of the invention, the release space (100) may be formed in a portion of the holding member (47) located on an outer circumferential surface of the blade member (30).

The release space (100) is formed in a portion of the holding member (47) of the third aspect of the invention located on the outer circumferential surface of the blade member (30). Thus, the high-pressure gas generated in the back pressure chamber (49) is guided to the perimeter of the blade member (30) so as to be fed to the release space (100). This facilitates preventing the high-pressure gas from flowing to the target portion (40) of the current-carrying member (12).

According to a fourth aspect of the invention, in the third aspect of the invention, the release space (100) may include at least one radial passage (102, 103, 110, 120) radially extending through the portion of the holding member (47) located on the outer circumferential surface of the blade member (30).

According to the fourth aspect of the invention, the high-pressure gas generated in the back pressure chamber (49) flows radially outward of the blade member (30) through the radial passage (102, 103, 110, 120). This facilitates preventing the high-pressure gas from flowing to the target portion (40) of the current-carrying member (12).

According to a fifth aspect of the invention, in any one of the first through fourth aspects of the invention, a thin wall (151) may be formed at an inlet end of the release space (100), and before the blade member (30) cuts the current-carrying member (12), the thin wall (151) may block the release space (100) to form an inner circumferential surface of the holding member (47), and may be broken by high-pressure gas generated by the gas generator (35).

According to the fifth aspect of the invention, the thin wall (151) is formed at the inlet end of the release space (100). The thin wall (151) blocks the inlet end of the release space (100) before the blade member (30) cuts the current-carrying member (12). Thus, the thin wall (151) forms an inner circumferential surface of the holding member (47) facing the blade member (30). When high-pressure gas is generated by the gas generator (35), and the blade member (30) cuts the current-carrying member (12), the pressure of the high-pressure gas allows a break in the thin wall (151). As a result, the back pressure chamber (49) and the release space (100) communicate with each other, and the high-pressure gas flows out into the release space (100).

According to a sixth aspect of the invention, in any one of the first through fifth aspects of the invention, the holding member (47) may include an inner cylinder (24) accommodating the blade member (30) such that the blade member (30) is movable, and a case (20) accommodating the inner cylinder (24) and the current-carrying member (12), the release space (100) may include an inner-cylinder-side passage (110) formed in the inner cylinder (24), and having an outlet end that opens through an outer circumferential surface of the inner cylinder (24), and a case-side passage (120) formed in the case (20) to communicate with the outlet end of the inner-cylinder-side passage (110), and a sealing portion (152, 153, 154, 155, 156) may be formed between the inner cylinder (24) and the case (20) to prevent gas that has flowed out of the inner-cylinder-side passage (110) from flowing to the cut current-carrying member (12).

According to the sixth aspect of the invention, the generation of the high-pressure gas allows the blade member (30) to cut the current-carrying member (12), and thus, the high-pressure gas in the back pressure chamber (49) flows through the inner-cylinder-side passage (110) and the case-side passage (120) in sequential order, and is discharged to outside the holding member (47). In this case, the high-pressure gas attempts to flow through the gap between the inner cylinder (24) and the case (20) accommodating the inner cylinder (24) to the cut current-carrying member (12). However, in the present invention, the sealing portion (152, 153, 154, 155, 156) is formed between the inner cylinder (24) and the case (20), thereby preventing the leakage of the high-pressure gas.

According to a seventh aspect of the invention, in any one of the first through sixth aspects of the invention, the holding member (47) may include an inner cylinder (24) accommodating the blade member (30) such that the blade member (30) is movable, a holding portion (13) accommodating the inner cylinder (24) and the current-carrying member (12), and a cover (14) covering the holding portion (13), and the release space (100) may include an inner-cylinder-side passage (110) formed in the inner cylinder (24), and a case-side passage (120) formed in the holding portion (13) to communicate with an outlet end of the inner-cylinder-side passage (110), and having an outlet end that opens toward a wall surface of the cover (14).

According to the seventh aspect of the invention, the generation of the high-pressure gas allows the blade member (30) to cut the current-carrying member (12), and thus, the high-pressure gas in the back pressure chamber (49) flows through the inner-cylinder-side passage (110) and the case-side passage (120) in sequential order. The high-pressure gas that has flowed through the case-side passage (120) flows out to a wall surface of the cover (14). Thus, the cover (14) can reduce the pressure of the gas that has flowed out of the exhaust gas passage (100).

According to an eighth aspect of the invention, in the seventh aspect of the invention, a sealing portion (133, 144) may be formed between the holding portion (13) and the cover (14) to prevent gas that has flowed out of the case-side passage (120) from flowing to the cut current-carrying member (12).

According to the eighth aspect of the invention, the sealing portion (133, 144) is formed between the holding portion (13) and the cover (14). This prevents the gas that has flowed out of the case-side passage (120) from leaking through the gap between the holding portion (13) and the cover (14) to the current-carrying member (12).

According to a ninth aspect of the invention, in any one of the first through sixth aspects of the invention, the release space (100) may include a gas outlet (103a) that opens toward a conductive portion (41) of the current-carrying member (12) different from the target portion (40).

According to the ninth aspect of the invention, the high-pressure gas fed from the back pressure chamber (49) to the release space (100) flows out through the gas outlet (103a) to the conductive portion (41) of the current-carrying member (12). Thus, the conductive portion (41) can reduce the pressure of the gas that has flowed out of the release space (100).

According to a tenth aspect of the invention, in any one of the first through ninth aspects of the invention, the current-carrying member (12) may have a pair of conductive portions (41, 41) that are located laterally outward of the target portion (40) and into which the current-carrying member (12) is divided by cutting the target portion (40) away with the blade member (30), and the release space (100) may be formed in a portion of the holding member (47) near one of the pair of the conductive portions (41, 41).

According to the tenth aspect of the invention, the blade member (30) cuts the current-carrying member (12) to electrically disconnect the pair of conductive portions (41, 41) from each other. In this situation, if a space between the conductive portions (41, 41) is filled with the high-pressure gas that has leaked through the release space (100), the conductive portions are electrically connected together through the high-pressure gas. To address this problem, in the present invention, the release space (100) is formed in a portion of the holding member (47) near one of the conductive portions (41). Therefore, even if the high-pressure gas leaks through the release space (100), the space between the conductive portions (41, 41) can be prevented from being filled with the high-pressure gas.

### Advantages of the Invention

According to the present invention, the back pressure chamber (49) is brought into communication with the release space (100) after the target portion (40) has been cut, thereby reducing the flow of the high-pressure gas to the target portion (40) of the current-carrying member (12). This can prevent portions into which the current-carrying member (12) is divided from being electrically connected together through the high-pressure gas. This can ensure electrical insulation between the portions into which the current-carrying member (12) is divided, thereby improving the reliability of the cutter.

According to the second aspect of the invention, the high-pressure gas in the back pressure chamber (49) is discharged through the exhaust gas passage (100) to the holding member (47). This can reliably prevent the high-pressure gas in the back pressure chamber (49) from flowing to the target portion (40) of the current-carrying member (12).

When, as such, the internal pressure of the back pressure chamber (49) is decreased, the used cutter can be safely handled. Specifically, when the internal pressure of the back pressure chamber (49) is high after the use of the cutter, the high-pressure gas in the back pressure chamber (49) may issue after the discarding of the cutter or during disassembly of the cutter, and thus, may cause risks. To address this problem, in the present invention, the internal pressure of the back pressure chamber (49) is reduced after the cutting of the current-carrying member (12). This can ensure safety after the use of the cutter.

According to the third aspect of the invention, the release space (100) is formed in a portion of the holding member (47) located on the outer circumferential surface of the blade member (30), thereby reliably preventing the high-pressure gas from flowing to the current-carrying member (12). In particular, according to the fourth aspect of the invention, the radial passage (102, 103, 110, 120) is extended through the holding member (47), and thus, the high-pressure gas can be reliably guided in a direction different from the direction toward the target portion (40) of the current-carrying member (12).

According to the fifth aspect of the invention, the thin wall (151) is formed at the inlet end of the release space (100), thereby preventing the outer circumferential surface of the blade member (30) from being caught on the edge of an inlet of the release space (100). This can prevent the high-pressure gas in the back pressure chamber (49) from leaking to the current-carrying member (12) due to, e.g., a depression formed in the outer circumferential surface of the blade member (30) or the inner wall of the holding member (47). When the thin wall (151) is formed at the inlet end of the release space (100) as above, this prevents the formation of burrs after the injection molding for the release space (100). This can improve the quality of the finished release space (100), and reduce the number of process steps.

According to the sixth aspect of the invention, the high-pressure gas can be prevented from passing through the gap between the inner cylinder (24) and the case (20) and reaching the current-carrying member (12). Furthermore, according to the eighth aspect of the invention, the high-pressure gas can be prevented from passing through the gap between the holding portion (13) and the cover (14) and reaching the current-carrying member (12). Therefore, the sixth and eighth aspects of the invention can ensure electrical insulation between the portions into which the current-carrying member (12) is divided, thereby improving the reliability of the cutter.

According to the seventh aspect of the invention, the high-pressure gas that has flowed out of the case-side passage (120) is brought into contact with the cover (14), and thus, the pressure of the high-pressure gas can be reduced. This can prevent the high-pressure gas from issuing to outside the holding member (47) at a relatively high flow rate.

Furthermore, according to the ninth aspect of the invention, the high-pressure gas in the release space (100) is brought into contact with the conductive portion (41) via the gas outlet (103a), and thus, the pressure of the high-pressure gas can be reduced. This can prevent the holding member (47) from being broken due to the pressure of the high-pressure gas fed to the release space (100), or prevent the high-pressure gas from rapidly issuing to outside the holding member (47). The high-pressure gas passing through the release space (100) has a relatively high temperature. However, in the present invention, the high-pressure gas can be prevented from being directly blown to the holding member (47), thereby preventing the holding member (47) from being molten or broken due to the influence of heat. Moreover, the high-pressure gas having a relatively high temperature can be prevented from rapidly issuing to outside the holding member (47).

According to the tenth aspect of the invention, the high-pressure gas can be guided to one of the conductive portions (41, 41) that are both side portions of the current-carrying member (12). Therefore, the tenth aspect of the invention can further ensure electrical insulation between the portions into which the current-carrying member (12) is divided.

### BRIEF DESCRIPTION OF THE DRAWINGS

FIG. 1 is a plan view illustrating a cutter according to a first embodiment, and illustrates the condition of the cutter before generation of high-pressure gas.

FIG. 2 is a cross-sectional view taken along the line II-II in FIG. 1.

FIG. 3 is a cross-sectional view taken along the line III-III in FIG. 1.

FIG. 4 is a perspective view illustrating an external structure of the cutter according to the first embodiment.

FIG. 5 is a perspective view illustrating an internal structure of the cutter according to the first embodiment.

FIG. 6 is a perspective view illustrating a blade and a harness according to the first embodiment.

FIG. 7 is a perspective view illustrating the blade according to the first embodiment.

FIG. 8 is a plan view illustrating the cutter according to the first embodiment, and illustrates the condition of the cutter after generation of high-pressure gas.

FIG. 9 is a cutaway plan view of a cutter according to a second embodiment, and illustrates the condition of the cutter before generation of high-pressure gas.

FIG. 10 is a cross-sectional view taken along the line X-X in FIG. 9.

FIG. 11 is a cross-sectional view taken along the line XI-XI in FIG. 10, where a portion of a harness has been omitted.

FIG. 12 is a perspective view illustrating an external structure of the cutter according to the second embodiment.

FIG. 13 is a perspective view illustrating an internal structure of the cutter according to the second embodiment.

FIG. 14 is a perspective view illustrating an internal structure of a cover according to the second embodiment.

FIG. 15 is a perspective view illustrating an external structure of a second inner cylinder member according to the second embodiment.

FIG. 16 is a perspective view illustrating a cutting portion of a blade according to the second embodiment.

FIG. 17 is a cross-sectional view taken along the line XVII-XVII in FIG. 10.

FIG. 18 is a cutaway plan view of the cutter according to the second embodiment, and illustrates the condition of the cutter after generation of high-pressure gas.

FIG. 19(A) is a block diagram schematically illustrating an exhaust gas passage of a cutter according to a first variation and its surrounding region, and illustrates the conditions of the exhaust gas passage and its surrounding region before a break in a thin wall. FIG. 19(B) is a block diagram schematically illustrating the exhaust gas passage of the cutter according to the first variation and its surrounding region, and illustrates the conditions of the exhaust gas passage and its surrounding region after the break in the thin wall.

FIG. 20 is a block diagram schematically illustrating an exhaust gas passage of a cutter according to a second variation and its surrounding region.

FIG. 21 is a block diagram schematically illustrating an exhaust gas passage of a cutter according to a third variation and its surrounding region.

FIG. 22 is a block diagram schematically illustrating an exhaust gas passage of a cutter according to a fourth variation and its surrounding region.

FIG. 23 is a block diagram schematically illustrating an exhaust gas passage of a cutter according to a fifth variation and its surrounding region.

FIG. 24 is a schematic block diagram illustrating a breaker according to a third embodiment.

FIG. 25 is a schematic block diagram illustrating a contactor according to a fourth embodiment.

FIG. 26 is a schematic block diagram illustrating an electric circuit breaker according to a fifth embodiment.

### DESCRIPTION OF EMBODIMENTS

Embodiments of the present invention will be described hereinafter in detail with reference to the drawings.

### First Embodiment of the Invention

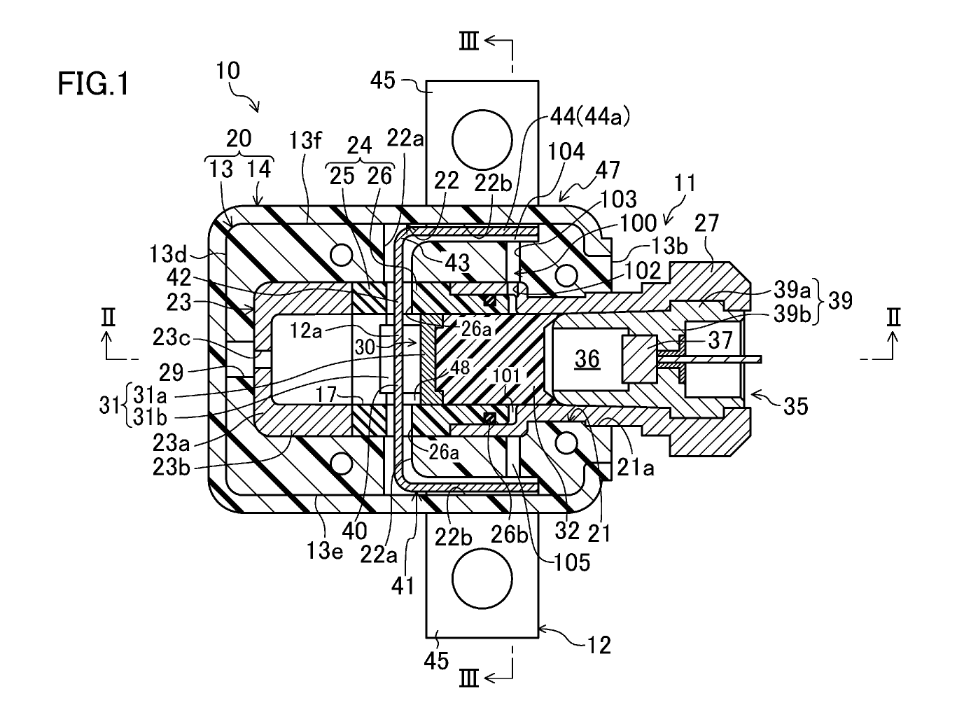

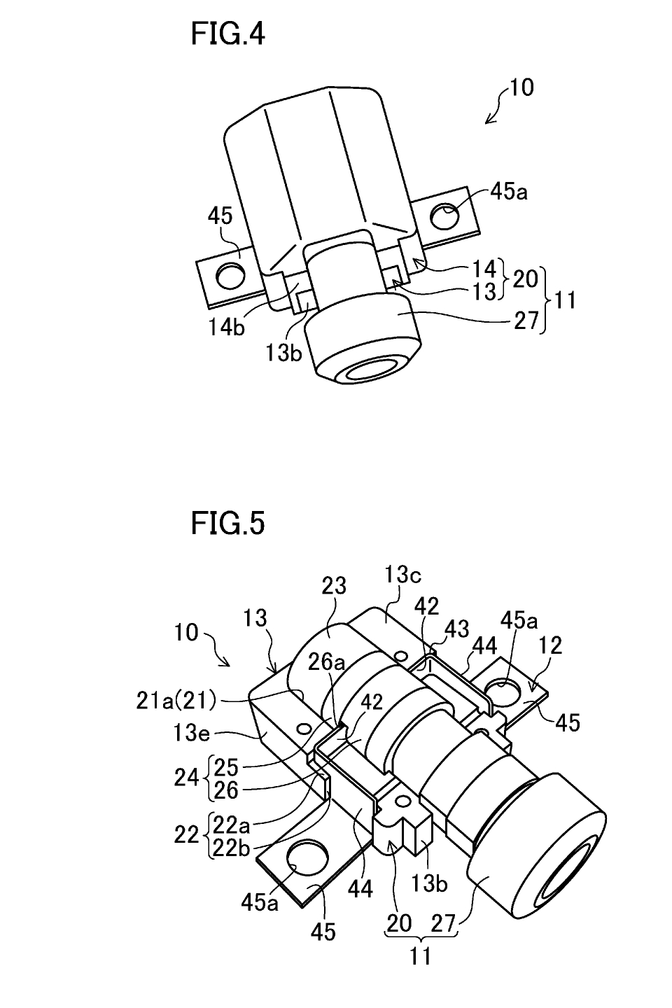

As illustrated in FIGS. 1-5, a cutter (10) according to a first embodiment is configured to cut a harness (12) forming a current-carrying member while moving a blade (30) forward using high-pressure gas generated by the reaction of a gas-generating agent. The cutter (10) uses an explosive as the gas-generating agent for generating high-pressure gas.

The cutter (10) includes a case (11) as illustrated in FIGS. 1 and 5, and a stopper (23), an inner cylinder (24), a blade (30), and a gas generator (35) are accommodated in the case (11).

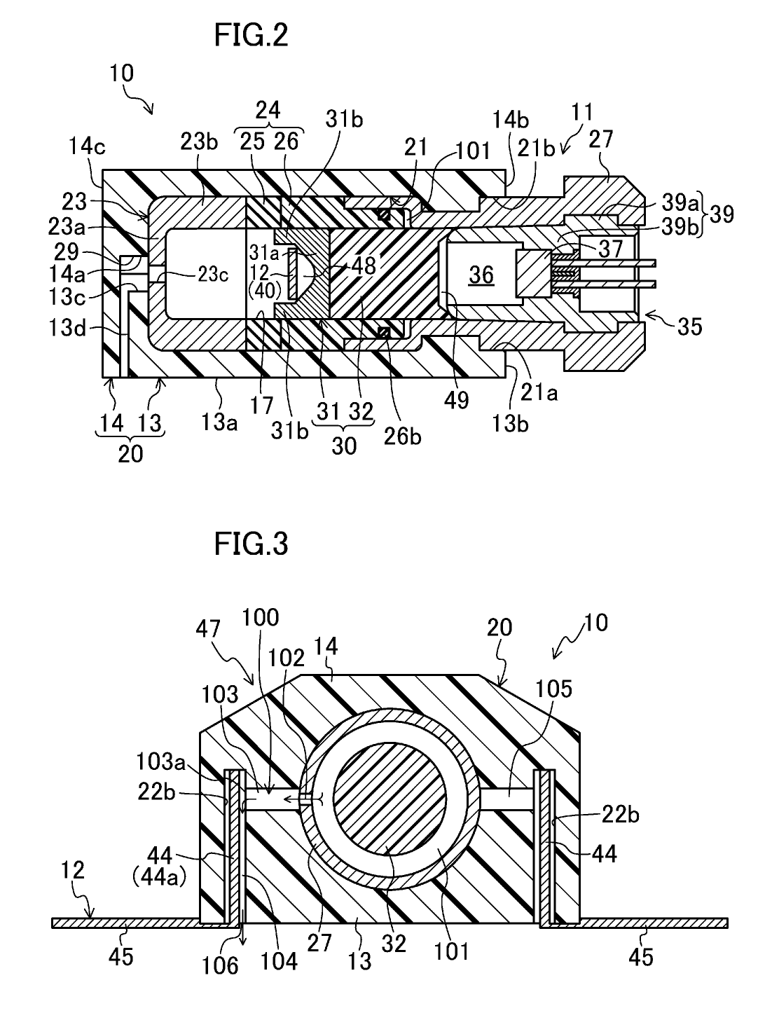

For convenience of explanation, the left-hand side of FIG. 2 is hereinafter referred to as the “front side,” the right-hand side of FIG. 2 is hereinafter referred to as the “back side,” the upper side of FIG. 2 is hereinafter referred to as the “upper side,” and the lower side of FIG. 2 is hereinafter referred to as the “lower side.” The front side of the drawing sheet of FIG. 2 in the direction orthogonal to the drawing sheet is hereinafter referred to as the “left side,” and the back side thereof is hereinafter referred to as the “right side.”

<Principal Structure of Cutter>

As illustrated in FIGS. 1, 2, 4, and 5, the case (11) includes a box-shaped resin case (20), and a cylindrical metal case (27). A front portion of the metal case (27) is accommodated in a below-described through hole (21) through the resin case (20).

The resin case (20) is made of e.g., a resin, such as PC (polycarbonate). The resin material forming the resin case (20) is not limited to the PC, and may be a resin material containing, e.g., plastic. The resin case (20) includes a base (13) formed in the shape of a rectangular parallelepiped and forming a holding member, and a cover (14) continuously covering surfaces of the base (13) except lower and back surfaces (13a) and (13b) thereof.

A groove (21a) having a semicircular cross-sectional shape is formed in an upper surface (13c) of the base (13) (see FIG. 5). The groove (21a) extends from the back surface (13b) of the base (13) to a front surface (13d) thereof, and opens only through the back surface (13b).

The cover (14) covers the upper surface (13c), front surface (13d), left surface (13e), and right surface (13f) of the base (13). A groove (21b) is formed in an opposed surface (14a) of the cover (14) facing the upper surface (13c) of the base (13) to correspond to the groove (21a) of the base (13). The groove (21b) extends from a back surface (14b) of the cover (14) to a front surface (14c) thereof, and opens only through the back surface (14b).

With this configuration, the generally cylindrical through hole (21) is formed in the resin case (20) by the groove (21a) of the base (13) and the groove (21b) of the cover (14), and opens through a back end surface of the resin case (20). The stopper (23), the inner cylinder (24), and a front portion of the metal case (27) are accommodated in the through hole (21) in sequential order from the front end of the through hole (21) toward the back end thereof.

The stopper (23) is configured to receive and stop the travelling blade (30). The stopper (23) is disposed in a front end portion of the through hole (21), made of a resin material, and formed in the shape of a bottomed cylinder. Specifically, the stopper (23) has a disk-like bottom portion (23a), and a cylindrical cylinder portion (23b), and the bottom portion (23a) is disposed in a region of the front end portion of the through hole (21) located forward of the cylinder portion (23b). A hole (23c) is formed in a central portion of the bottom portion (23a) to communicate with an exhaust hole (29) of the resin case (20).

The inner cylinder (24) is disposed in a portion of the through hole (21) located behind the stopper (23) to support the harness (12). The inner cylinder (24) includes a first inner cylinder member (25) and a second inner cylinder member (26), and the harness (12) is sandwiched between the members (25, 26).

The first inner cylinder member (25) is made of ceramic, formed in a generally cylindrical configuration, and disposed in a portion of the through hole (21) behind the stopper (23) such that its axis is identical with the axis of the stopper (23). The first inner cylinder member (25) has an inside diameter enabling the insertion of the blade (30) through the first inner cylinder member (25).

The second inner cylinder member (26) is made of a resin material, formed in a generally cylindrical configuration, and disposed in a portion of the through hole (21) behind the first inner cylinder member (25) such that its axis is identical with the axis of the first inner cylinder member (25). The second inner cylinder member (26) has an inside diameter substantially equal to the inside diameter of the first inner cylinder member (25). A back portion of the second inner cylinder member (26) is thinner than a front portion thereof, and has a smaller outside diameter than the front portion. Two cutouts (26a) through which the harness (12) is to be inserted are formed in the front portion of the second inner cylinder member (26). The two cutouts (26a) are located to correspond to a placement hole (22) of the resin case (20). The cutouts (26a) extend from the outer circumferential surface of the second inner cylinder member (26) toward the inner circumferential surface thereof, and each have a slightly larger rectangular cross section than the harness (12). An annular groove is formed in the outer circumferential surface of the thin back portion of the second inner cylinder member (26), and an O ring (26b) is placed in the groove.

As such, the inner cylinder (24) is configured such that the harness (12) is supported by sandwiching the harness (12) between the first and second inner cylinder members (25) and (26) that are insulating members.

The metal case (27) is a metal member formed in a generally cylindrical configuration, and has a front portion accommodated in the through hole (21), and a back portion exposed from the resin case (20). The front portion of the metal case (27) is located in a portion of the through hole (21) behind the second inner cylinder member (26) such that the axis of the metal case (27) is identical with the axis of the second inner cylinder member (26). A front end portion of the metal case (27) is fitted onto the thin back portion of the second inner cylinder member (26). The gap between the back portion of the second inner cylinder member (26) and the front end portion of the metal case (27) fitted onto the back portion is sealed with the O ring (26b). A portion of the front portion of the metal case (27) except the front end portion thereof has an inside diameter substantially equal to the inside diameter of the second inner cylinder member (26).

As described above, the stopper (23), the inner cylinder (24), and the metal case (27) accommodated in the through hole (21) internally form a generally cylindrical passage (17), and a portion of the cylindrical passage (17) forms a path through which the blade (30) travels. The cylindrical passage (17) has a front end blocked by the below-described bottom portion (23a) of the stopper (23), and a back end blocked by the gas generator (35) accommodated in the metal case (27). A portion of a narrow portion (12a) of the harness (12) accommodated in the placement hole (22) is exposed to the cylindrical passage (17), and the blade (30) is accommodated in a space between the exposed portion and the gas generator (35).

The gas generator (35) is configured to generate high-pressure gas serving to move the blade (30) forward to cut the harness (12). The gas generator (35) includes an explosive used as a gas-generating agent, an igniter (37) configured to initiate the explosive, and a lid member (39) configured to hold the igniter (37) and block the back end of the cylindrical passage (17).

The lid member (39) includes a cylinder portion (39a) formed in a generally cylindrical configuration and fitted into the metal case (27), and a blocking portion (39b) configured to hold the igniter (37) and block a middle portion of the cylinder portion (39a). The cylinder portion (39a) and the blocking portion (39b) are made of a metal material, and are integrally connected together. A closed space is formed in a portion of the cylindrical passage (17) behind the blade (30) by the blocking portion (39b), and the closed space forms a gas generation chamber (36) filled with the explosive.

The igniter (37) is a detonator, and is held by the blocking portion (39b) of the lid member (39) such that a front end portion of the igniter (37) including a primary explosive is exposed in the gas generation chamber (36).

With this configuration, when the igniter (37) allows the explosive in the gas generation chamber (36) to explode, high-pressure gas is generated in the gas generation chamber (36), and the high-pressure gas increases the internal pressure of the gas generation chamber (36) to move the blade (30) forward.

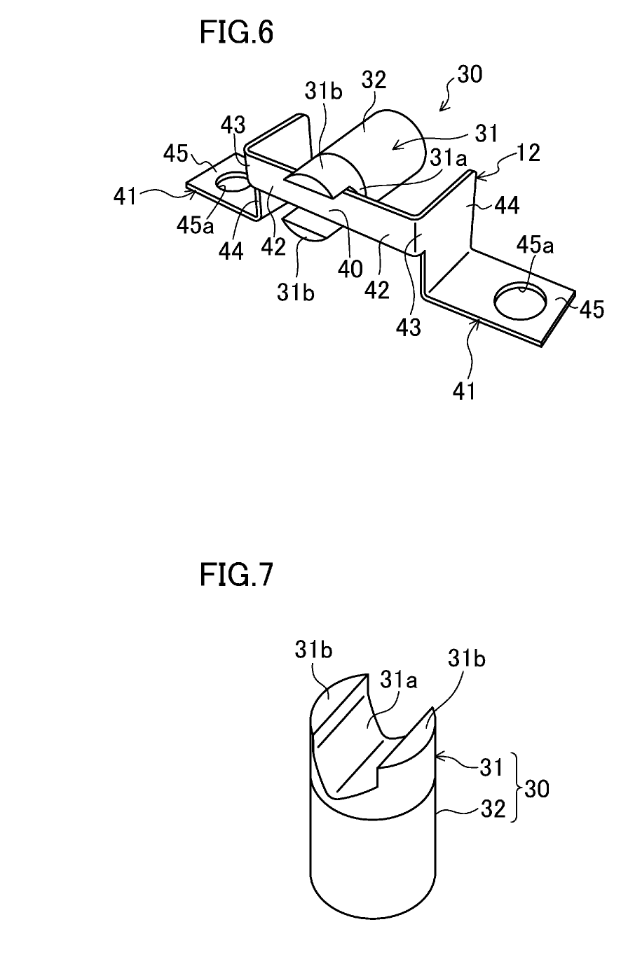

The blade (30) forms a blade member configured to move forward through the cylindrical passage (17) under the pressure of the high-pressure gas to cut a target portion (40) of the harness (12). As illustrated in FIGS. 6 and 7, the blade (30) includes a cutting portion (31) made of a metal material (e.g., steel), and a pusher (32) to which the cutting portion (31) is secured.

The pusher (32) is configured to hold the cutting portion (31), and move the cutting portion (31) forward under the pressure of the high-pressure gas generated in the gas generation chamber (36). The pusher (32) is made of a resin material, formed in a generally cylindrical configuration, and accommodated in a portion of the cylindrical passage (17) located forward of the gas generator (35). The pusher (32) has a slightly larger diameter than the below-described cutting portion (31).

The cutting portion (31) is secured to a front end portion of the pusher (32), and has an edge portion (31a), and a pair of guide portions (31b, 31b) integrally connected to the edge portion (31a). The edge portion (31a) is a thick disk-like member, and a vertically central portion of a front surface of the edge portion (31a) is recessed back. By contrast, the pair of guide portions (31b, 31b) are protrusions protruding forward from upper and lower end portions of the front surface of the edge portion (31a). The pair of guide portions (31b, 31b) protrude forward of the harness (12) from the front surface of the edge portion (31a) while avoiding the harness (12). The inner surfaces of the guide portions (31b, 31b) are shaped along the side surfaces of the harness (12), and the outer surfaces thereof are shaped along the surface of the wall of the cylindrical passage (17). A region of an outer portion of the front surface of the edge portion (31a) between the pair of guide portions (31b, 31b) forms a cutting edge portion configured to cut the harness (12).

<Configuration of Harness>

The harness (12) is made of a long bent metal plate. As illustrated in FIGS. 1-6, the harness (12) has the target portion (40) corresponding to the cutting portion (31) of the blade (30), and a pair of conductive portions (41) formed laterally outward from the target portion (40). The pair of conductive portions (41) includes a pair of longitudinal plate portions (42, 42), a pair of bent plate portions (43, 43), and a pair of side plate portions (44, 44), and a pair of support plate portions (45, 45), and the plate portions are integrally connected together.

The longitudinal plate portions (42, 42) extend laterally outward from the target portion (40) to be flush with the target portion (40). The longitudinal plate portions (42, 42) form a pair of conductive portions extending in a direction orthogonal to the direction of movement of the blade (30). The bent plate portions (43, 43) are members that are each bent backward from the outermost lateral end of a corresponding one of the longitudinal plate portions (42, 42) and have a generally L-shaped horizontal cross section. The side plate portions (44, 44) are connected to the back ends of the bent plate portions (43, 43), and each have a larger vertical width than each of the longitudinal plate portions (42). Among the side plate portions (44, 44), a right side plate portion (44a) forms an impingement plate (conductive portion) facing a gas outlet (103a) described below in detail. The support plate portions (45, 45) extend laterally outward from the lower ends of the side plate portions (44, 44). The support plate portions (45, 45) have fastening holes (45a, 45a) formed to fasten the cutter (10) to a predetermined fixing member.

<Harness Placement Structure>

The placement hole (22) in which the harness (12) is to be placed is formed in the cutter (10). The placement hole (22) is formed astride the base (13) and cover (14) of the resin case (20). The placement hole (22) is symmetric with respect to a vertical plane including the axis of the through hole (21). Specifically, the placement hole (22) includes a pair of longitudinal holes (22a, 22a), and a pair of side holes (22b, 22b). The longitudinal holes (22a, 22a) are formed laterally outward from the target portion (40) of the harness (12) while each communicating with a corresponding one of the cutouts (26a) of the second inner cylinder member (26). The longitudinal plate portions (42, 42) are each placed in a corresponding one of the longitudinal holes (22a). The side holes (22b, 22b) are formed laterally and radially outward from the blade (30) while each communicating with one of the longitudinal holes (22a) adjacent to the side hole (22b). The side plate portions (44, 44) are each placed in a corresponding one of the side holes (22b, 22b). The upper and back ends of the side holes (22b) are blocked by the resin case (20), and the side holes (22b) extend toward a lower end surface of the base (13) (see FIG. 3).

<Configurations of Blade Holding Member and Exhaust Gas Passage>

In the cutter (10), the resin case (20), the metal case (27), and the second inner cylinder member (26) forms a cylindrical blade holding member (47) in which the blade (30) is movably accommodated. In other words, the blade holding member (47) has an exposure opening (48) to which the target portion (40) of the harness (12) is exposed at one axial end (front end) of the blade holding member (47). A portion of the blade holding member (47) toward the other axial end (back end) thereof defines a back pressure chamber (49) facing a back end portion of the blade (30). The back pressure chamber (49) forms a portion of the above-described gas generation chamber (36).

A cylinder portion of the blade holding member (47) surrounding the blade (30) has an exhaust gas passage (100) configured to discharge the high-pressure gas generated in the gas generation chamber (36) to outside the back pressure chamber (49). The exhaust gas passage (100) communicates with the back pressure chamber (49) after the generation of the high-pressure gas to serve also as a release space functioning to reduce the pressure of the back pressure chamber (49). The configuration of the exhaust gas passage (100) will be described in detail with reference to FIGS. 1 and 3.

The exhaust gas passage (100) includes an annular passage (101), a communicating path (102), a groove passage (103), and an exhaust passage (104) in sequential order from the upstream end of the exhaust gas passage (100) through which the high-pressure gas flows toward the downstream end thereof.

The annular passage (101) is formed toward the back end of the second inner cylinder member (26). Specifically, the blade holding member (47) is configured such that the second inner cylinder member (26) is fitted into the metal case (27) with an inner wall surface of the metal case (27) (opposite to a back end surface of the second inner cylinder member (26)) spaced apart from a back end surface of the second inner cylinder member (26). Thus, the annular passage (101) that is an annular space is formed between the second inner cylinder member (26) and the metal case (27).

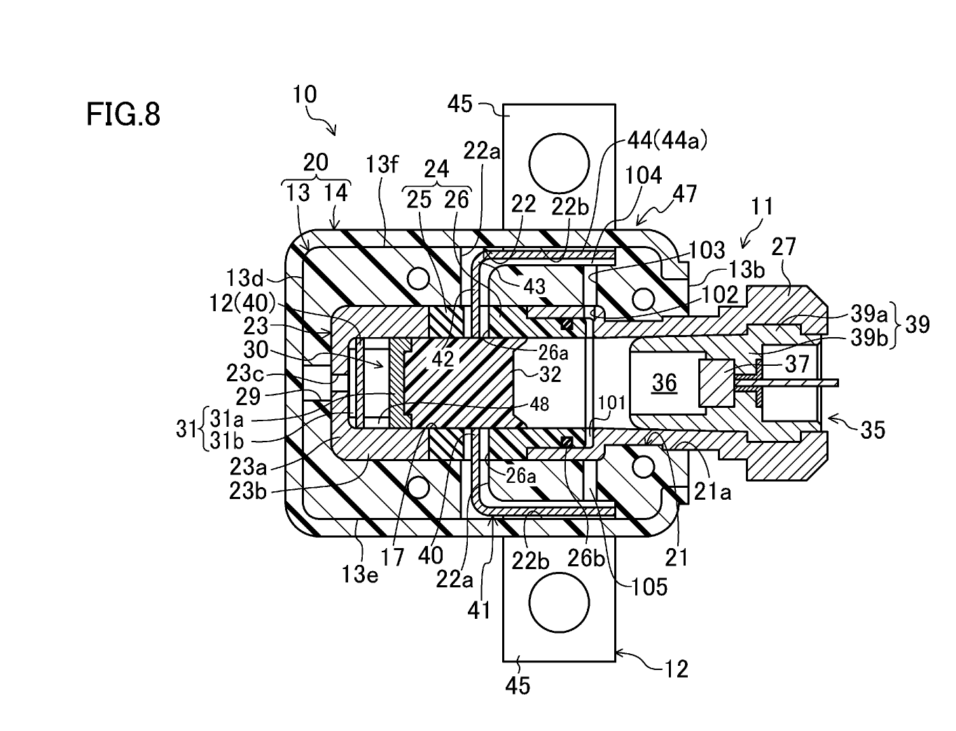

The annular passage (101) is configured such that the movement of the blade (30) allows the state of communication between the annular passage (101) and the back pressure chamber (49) to be changed. Specifically, before the generation of high-pressure gas in the gas generation chamber (36) (i.e., when the blade (30) is located, e.g., as illustrated in FIG. 1 before the harness (12) is cut by the blade (30)), the annular passage (101) is disconnected from the back pressure chamber (49). By contrast, after the generation of high-pressure gas in the gas generation chamber (36) (i.e., when the blade (30) is located, e.g., as illustrated in FIG. 8 after the harness (12) has been cut by the blade (30)), the annular passage (101) communicates with the back pressure chamber (49).

The communicating path (102) passes through the metal case (27). An inlet end of the communicating path (102) is connected to the annular passage (101) such that the communicating path (102) communicates with the annular passage (101). An outlet end of the communicating path (102) is connected to the groove passage (103) such that the communicating path (102) communicates with the groove passage (103). The communicating path (102) forms a passage extending radially outward through the blade holding member (47). The communicating path (102) is formed in a portion of the metal case (27) near one (right one in FIG. 1) of the pair of conductive portions (41, 41) of the harness (12). The longitudinal cross section of the communicating path (102) (cross section of the passage) is circular.

The groove passage (103) is formed in the upper surface (13c) of the base (13) (see, e.g., FIG. 5). Similar to the communicating path (102), the groove passage (103) extends radially outward through the blade holding member (47). An outlet end of the groove passage (103) is connected to the exhaust passage (104) such that the groove passage (103) communicates with the exhaust passage (104). The groove passage (103) is a groove having, e.g., a semicircular or rectangular longitudinal cross section. The cross-sectional area of the groove passage (103) is larger than that of the communicating path (102). A groove may be formed in a portion of the cover (14) of the resin case (20) opposite to the groove passage (103). This can further increase the cross-sectional area of the groove passage (103) formed in the resin case (20).

The communicating path (102) and the groove passage (103) both described above form a radial passage extending in a direction orthogonal to the direction of movement of the blade (30).

An auxiliary groove passage (105) is formed in a portion of the upper surface (13c) of the base (13) opposite to the above-described groove passage (103) with respect to a vertical plane including the axis of the blade holding member (47). The auxiliary groove passage (105) does not usually communicate with the communicating path (102), and thus, does not form a portion of the exhaust gas passage (100). However, if, in a process step of assembling the cutter (10), a worker has assembled the cutter (10) with the metal case (27) rotated 180° from the orientation of the metal case (27) illustrated in FIG. 3 about the axis, the communicating path (102) communicates with the auxiliary groove passage (105). In this case, similar to the above-described groove passage (103), the auxiliary groove passage (105) functions as a portion of the exhaust gas passage (100). In other words, the auxiliary groove passage (105) is a reserve passage configured to ensure the formation of the exhaust gas passage (100) even when the cutter (10) is assembled with the metal case (27) flipped 180°.

The exhaust passage (104) is a space corresponding to a portion of one of the side holes (22b) (right side hole (22b)) defined inside a corresponding one of the side plate portions (44a) of the harness (12). The exhaust passage (104) is formed in a laterally flat rectangular parallelepiped configuration. The exhaust passage (104) extends vertically downward from its inlet end to its outlet end through the base (13). The outlet end (106) of the exhaust passage (104) opens through the lower surface (13a) of the base (13). The outlet end (106) forms a gas exhaust port through which high-pressure gas in the blade holding member (47) is discharged to the outside.

The side plate portion (44a) of the harness (12) forms a portion of a wall surface for defining the exhaust passage (104). Furthermore, the side plate portion (44a) forms an impingement plate facing the gas outlet (103a) of the groove passage (103). The side plate portion (44a) is made of a more rigid material than that of the resin case (20) of the blade holding member (47). Thus, when the side plate portion (44a) receives the pressure of high-pressure gas exiting through the gas outlet (103a), this can prevent the resin case (20) from being damaged.

—Cutting Operation—

A principal operation of the cutter (10) of this embodiment will be described.

The cutter (10) of the first embodiment is provided such that the harness (12) of an electrical device in, e.g., a factory is inserted through the placement hole (22) to pass through a space between the first and second inner cylinder members (25) and (26). The harness (12) is supported while being sandwiched between the first and second inner cylinder members (25) and (26).

The cutter (10) is provided with the igniter (37) connected to, e.g., a fire alarm or an earthquake alarm. When the fire alarm detects fire, or when the earthquake alarm detects an earthquake, an alarm signal is fed to the igniter (37). When the alarm signal is fed to the igniter (37), the igniter (37) explodes the explosive in the gas generation chamber (36).

When the cutter (10) is in the position illustrated in FIG. 1, an explosion of the explosive in the gas generation chamber (36) allows the generation of high-pressure gas in the gas generation chamber (36). This suddenly increases the pressure of the hack pressure chamber (49) behind the blade (30). This increase allows the blade (30) to move forward using the pressure of the back pressure chamber (49) as a driving source. When the blade (30) moves forward, and its edge portion (31a) collides with the harness (12), a shearing force acts on the target portion (40) of the harness (12). Thus, the target portion (40) of the harness (12) is cut away such that the pair of conductive portions (41, 41) remain, and thus, the conductive portions (41, 41) are separated from each other. Consequently, the harness (12) becomes nonconductive.

The blade (30) that has cut the harness (12) further moves forward while holding the target portion (40). The blade (30) further moves forward while being in sliding contact with the inner circumferential surface of the stopper (23) to gradually decrease the driving force of the blade (30), abuts against the bottom portion (23a) of the stopper (23), and stops (see FIG. 8).

When the blade (30) is at rest after cutting the harness (12), the longitudinal plate portions (42, 42) into which the harness (12) has been cut are continuous with the insulative pusher (32) in a direction perpendicular to the axis of the pusher (32). This reliably prevents the pair of conductive portions (41, 41) from being again energized through the blade (30).

—High-Pressure Gas Discharge Operation—

When the cutter (10) cuts the harness (12), the explosion of the explosive allows the generation of high-pressure gas in the gas generation chamber (36). When, as such, high-pressure gas is generated in the back pressure chamber (49), the high-pressure gas may flow through the gap between the outer circumferential surface of the blade (30) and the inner circumferential surface of the cylindrical passage (17) to a space in the vicinity of the target portion (40) of the harness (12). When, as such, the high-pressure gas flows to a space between the conductive portions (41, 41) into which the harness (12) has been cut, a discharge, such as a spark, may be induced between the conductive portions (41, 41) through the high-pressure gas. In particular, high-pressure gas generated by the explosion of the explosive contains conductive impurities (e.g., carbon, such as soot), and thus, the electrical conductivity of the high-pressure gas tends to increase. Thus, such high-pressure gas flows to a region surrounding the target portion (40) to impair electrical insulation between the conductive portions (41, 41), and thus, the reliability of the cutter (10) cannot be ensured. Here, in this embodiment, in order to avoid the leakage of such high-pressure gas, the exhaust gas passage (100) is formed in the cutter (10) to discharge high-pressure gas therethrough. Such a high-pressure gas discharge operation will be described with reference to FIGS. 1, 3, and 8.

Before the explosion of the explosive in the gas generation chamber (36), the blade (30) is located toward the back of the cutter (10) as illustrated in FIG. 1. In this situation, the annular passage (101) of the exhaust gas passage (100) is disconnected from the back pressure chamber (49). Therefore, when the blade (30) is in this position, and high-pressure gas is generated in the gas generation chamber (36), high-pressure gas does not flow out of the back pressure chamber (49) into the exhaust gas passage (100). In other words, when high-pressure gas is generated, the back pressure chamber (49) forms a closed space having a predetermined capacity, and thus, an increase in the pressure of the back pressure chamber (49) can be ensured. Thus, the pressure can be utilized to ensure the forward movement of the blade (30).

After, as such, the blade (30) has moved forward and cut the harness (12), the back pressure chamber (49) communicates with the annular passage (101). The back pressure chamber (49) preferably communicates with the annular passage (101) after the blade (30) has cut the harness (12) and before the blade (30) is at rest. When the back pressure chamber (49) communicates with the annular passage (101) before the blade (30) cuts the harness (12), this cannot ensure the cutting of the harness (12). By contrast, after the harness (12) has been cut, the back pressure chamber (49) preferably communicates with the annular passage (101) as soon as possible. The reason for this is that when the harness (12) is cut, and then, high-pressure gas in the back pressure chamber (49) is rapidly released to the exhaust gas passage (100), this can reliably prevent the high-pressure gas from leaking to the gap between the pair of conductive portions (41, 41).

When the back pressure chamber (49) communicates with the annular passage (101), the high-pressure gas in the back pressure chamber (49) flows into the annular passage (101). This decreases the pressure of the back pressure chamber (49). This decrease prevents the high-pressure gas in the back pressure chamber (49) from leaking through a gap around the blade (30) to the target portion (40) of the harness (12).

The high-pressure gas that has flowed into the annular passage (101) flows through the communicating path (102) into the groove passage (103). As such, the high-pressure gas is fed to one of the pair of side plate portions (44, 44) (to the side plate portion (44a)). This reliably prevents the high-pressure gas from flowing to the target portion (40) of the harness (12).

The high-pressure gas in the groove passage (103) flows through the gas outlet (103a) into the exhaust passage (104). The high-pressure gas impinges on a receiving surface of the side plate portion (44a) of the relatively rigid harness (12), and then, is guided downward along the side plate portion (44a). As above, a portion of the harness (12) receives the high-pressure gas to reliably prevent the resin case (20) or other components from being damaged. Furthermore, the high-pressure gas is fed in a direction opposite to the cover (14) (downward) to prevent the cover (14) from being sepaiated from the base (13).

The high-pressure gas that has flowed downward through the exhaust passage (104) is discharged through the outlet end (106) to outside the blade holding member (47). As described above, a fixing member to which the harness (12) is fastened is disposed under the base (13). This can prevent the high-pressure gas discharged to below the base (13) from impinging on, e.g., peripheral devices of the cutter (10).

### Advantages of First Embodiment

In the first embodiment, after the target portion (40) of the harness (12) has been cut, the back pressure chamber (49) is brought into communication with the exhaust gas passage (100) serving as a release space to reduce the leakage of high-pressure gas to the target portion (40) of the harness (12). This can prevent the conductive portions (41, 41) from being electrically continuous through the high-pressure gas due to the leakage of the high-pressure gas to the location at which the harness (12) has been cut (i.e., the gap between the pair of conductive portions (41, 41)). This can ensure the reliability of the cutter (10).

The high-pressure gas that has flowed into the exhaust gas passage (100) is fed radially outward of the blade (30) and toward one of the conductive portions (41), thereby reliably preventing the high-pressure gas from flowing to the target portion (40). In other words, in this embodiment, the high-pressure gas can be prevented from filling the gap between the pair of conductive portions (41, 41) due to the flow of the high-pressure gas to the location at which the harness (12) has been cut. This can prevent conductive impurities (e.g., carbon, such as soot) contained in the high-pressure gas from impairing electrical insulation between the conductive portions (41, 41), and prevent a spark between the conductive portions (41, 41).

Furthermore, the high-pressure gas is brought into contact with the side plate portion (44a) of the harness (12), thereby guiding the high-pressure gas to the outlet end (106) while reducing the pressure of the high-pressure gas. Furthermore, a portion of the harness (12) is utilized as an impingement plate for the high-pressure gas, thereby reducing the number of parts. The high-pressure gas passing through the exhaust gas passage (100) has a relatively high temperature. Thus, when the high-pressure gas is brought into contact with the harness (12), this can prevent the blade holding member (47) from being molten and damaged due to heat, and prevent the high-pressure gas having a high temperature from suddenly issuing to outside the blade holding member (47). In particular, the resin case (20) of the blade holding member (47) is made of a relatively heat-sensitive resin material, and thus, damage to the resin case (20) can be effectively prevented.

Moreover, in the embodiment, during the cutting operation, the high-pressure gas in the back pressure chamber (49) is discharged to outside the blade holding member (47), thereby reducing the internal pressure of the back pressure chamber (49). This enables safe discarding or disassembly of the cutter (10) after the cutting operation.

### Second Embodiment of the Invention

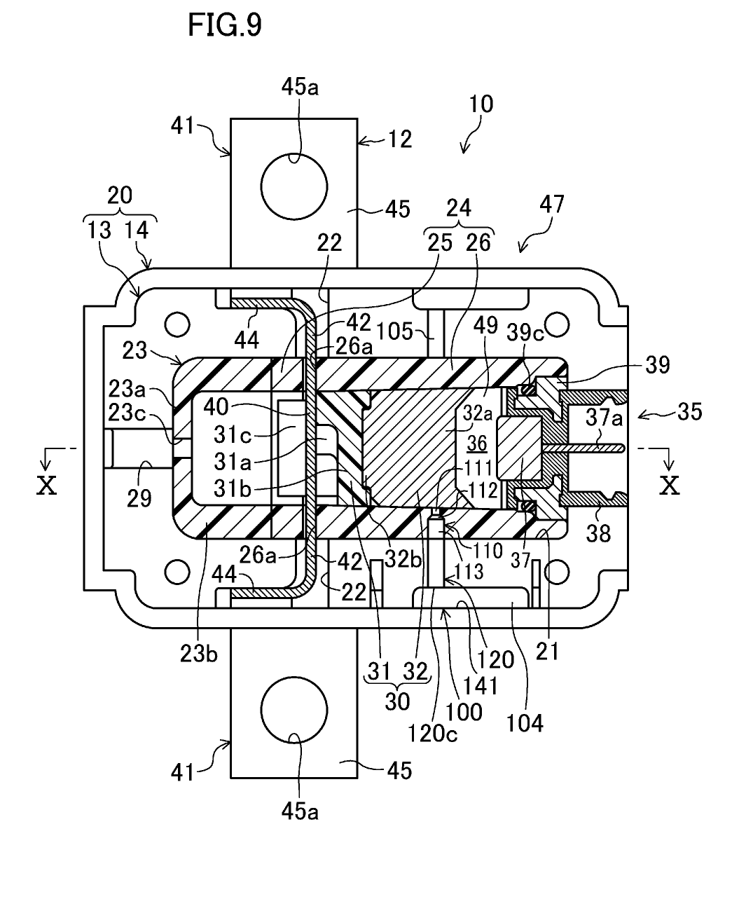

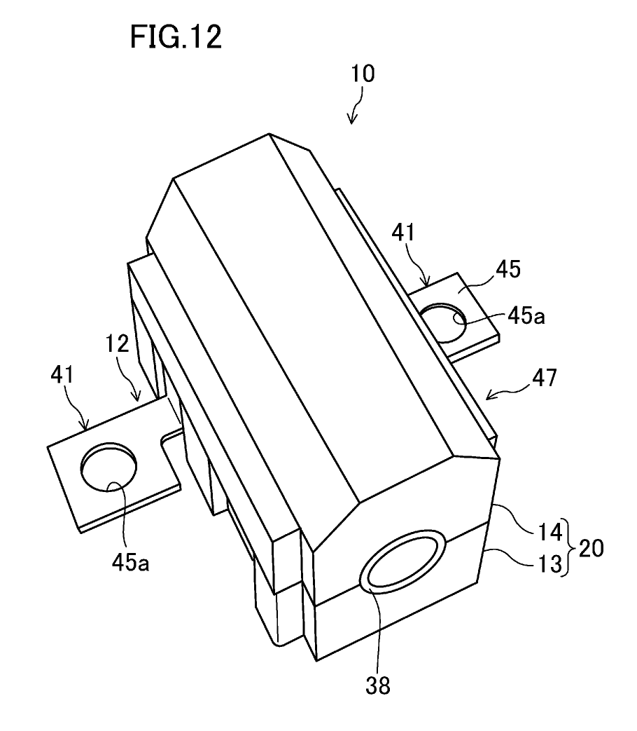

A cutter (10) according to a second embodiment has a different configuration from that of the first embodiment. As illustrated in FIGS. 9-14, the cutter (10) includes a resin case (20). A stopper (23), an inner cylinder (24), a blade (30), and a gas generator (35) are accommodated in the resin case (20). The resin case (20) and the inner cylinder (24) form a blade holding member (47) in which the blade (30) is movably accommodated.

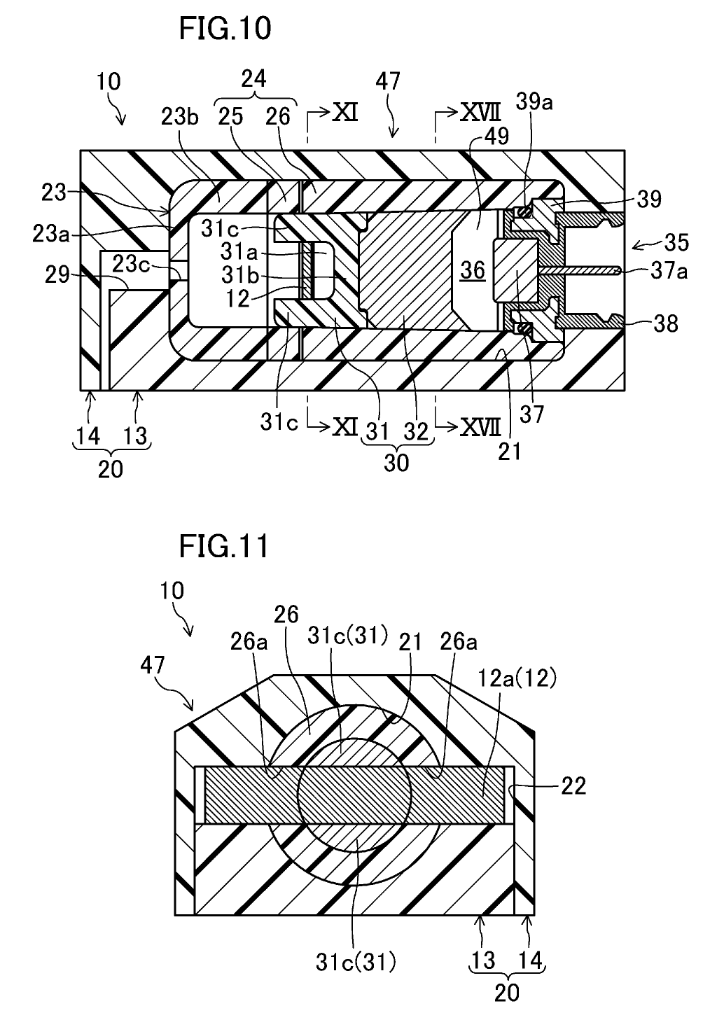

For convenience of explanation, the left-hand side of FIG. 10 is hereinafter referred to as the “front side,” the right-hand side of FIG. 10 is hereinafter referred to as the “back side,” the upper side of FIG. 10 is hereinafter referred to as the “upper side,” and the lower side of FIG. 10 is hereinafter referred to as the “lower side.” The front side of the drawing sheet of FIG. 10 in the direction orthogonal to the drawing sheet is hereinafter referred to as the “left side,” and the back side thereof is hereinafter referred to as the “right side.”

The resin case (20) is made of, e.g., a resin, such as PC (polycarbonate). The resin material forming the resin case (20) is not limited to the PC, and may be a resin material containing, e.g., plastic. The resin case (20) includes a base (13) formed in the shape of a generally rectangular parallelepiped and forming a generally lower half portion of the resin case (20), and a cover (14) continuously covering surfaces of the base (13) except lower and back surfaces thereof and forming a generally upper half portion of the resin case (20). In other words, the cover (14) covers upper, front, left, and right surfaces of the base (13). The base (13) forms a holding portion configured to accommodate the inner cylinder (24) and a harness (12).

The resin case (20) has a generally cylindrical through hole (21) formed astride the base (13) and the cover (14). The stopper (23), the inner cylinder (24), and the gas generator (35) are accommodated in the through hole (21) in sequential order from a front end of the through hole (21) to a back end thereof.

The resin case (20) has a placement hole (22) formed astride the base (13) and the cover (14), and configured to place the harness (12) therein. The placement hole (22) is symmetric with respect to a vertical plane including the axis of the through hole (21). Specifically, the placement hole (22) extends laterally outward from a longitudinally central portion of the through hole (21), is subsequently bent forward, is then bent downward, and extends to the lower surface of the base (13). The harness (12) is placed in the placement hole (22).

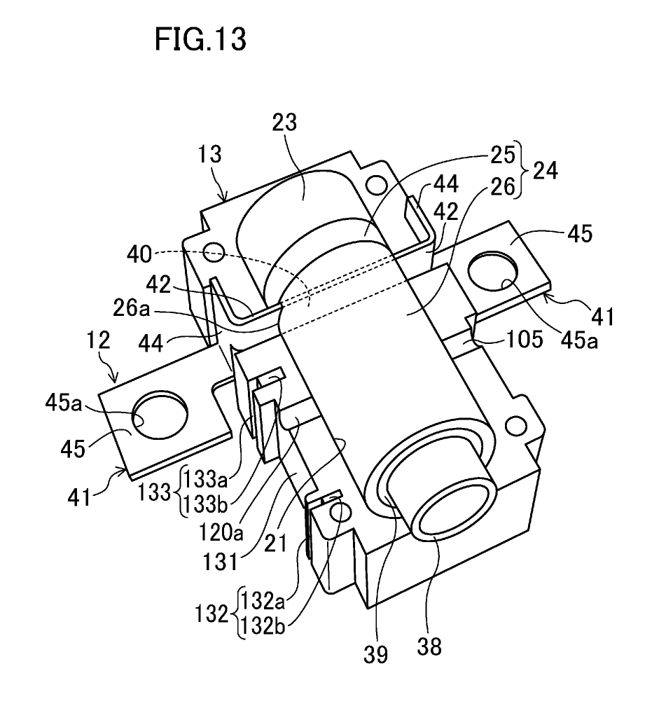

The harness (12) of the second embodiment is made of a long bent metal plate. As illustrated also in FIG. 13, the harness (12) has a target portion (40) formed at a location corresponding to the location of a cutting portion (31) of the blade (30), and a pair of conductive portions (41) formed laterally outward from the target portion (40). The pair of conductive portions (41) includes a pair of longitudinal plate portions (42, 42), a pair of side plate portions (44, 44) bent forward from the longitudinal plate portions (42, 42), and a pair of support plate portions (45, 45) connected to the lower ends of the side plate portions (44), and the plate portions are integrally connected together.

The longitudinal plate portions (42, 42) extend laterally outward from the target portion (40) to be flush with the target portion (40). The side plate portions (44, 44) of the second embodiment are located forward of the target portion (40) of the harness (12), and unlike the first embodiment, do not form an impingement plate. The support plate portions (45, 45) have fastening holes (45a, 45a) formed to fasten the cutter (10) to a predetermined fixing member. As described above, the conductive portions (41) of the harness (12) of the second embodiment are further away from a gas generation chamber (36) or a back pressure chamber (49) than those of the first embodiment. This can reduce the high-pressure gas generated in the gas generation chamber (36) and reaching the conductive portions (41), and ensures electrical insulation between portions into which the harness (12) has been cut.

The resin case (20) has an exhaust hole (29) formed to discharge air through a front end of the through hole (21). The exhaust hole (29) extends forward from the center of the front end of the through hole (21), is subsequently bent downward, and extends to the lower surface of the base (13).

The stopper (23) is configured to receive and stop the travelling blade (30). The stopper (23) is made of a resin material, and formed in the shape of a bottomed cylinder. Specifically, the stopper (23) has a disk-like bottom portion (23a), and a cylindrical cylinder portion (23b), and the bottom portion (23a) is located forward of the cylinder portion (23b). A hole (23c) is formed in a central portion of the bottom portion (23a) to communicate with the exhaust hole (29) of the resin case (20).

The inner cylinder (24) is disposed in a portion of the through hole (21) located behind the stopper (23) to support the harness (12). The inner cylinder (24) includes a first inner cylinder member (25) and a second inner cylinder member (26), and the harness (12) is sandwiched between the members (25, 26). The blade (30) is slidably accommodated in the inner cylinder (24).

The first inner cylinder member (25) is made of a resin material, formed in a generally cylindrical configuration, and disposed behind the stopper (23) such that its axis is identical with the axis of the stopper (23). The first inner cylinder member (25) has an inside diameter enabling the insertion of the blade (30) through the first inner cylinder member (25). The first inner cylinder member (25) may be made of ceramic.

The second inner cylinder member (26) is made of a resin material, formed in a generally cylindrical configuration, and disposed behind the first inner cylinder member (25) such that its axis is identical with the axis of the first inner cylinder member (25). The second inner cylinder member (26) has an inside diameter substantially equal to the inside diameter of the first inner cylinder member (25). As illustrated in FIG. 15, a front end surface (26c) of the second inner cylinder member (26) has two insertion grooves (26a) through which the longitudinal plate portions (42, 42) of the harness (12) are inserted. The two insertion grooves (26a) extend radially outward in the front end surface (26c), and are formed at locations corresponding to the location of the placement hole (22) of the resin case (20). As such, the inner cylinder (24) supports the harness (12) by sandwiching the longitudinal plate portions (42, 42) of the harness (12) between the first and second inner cylinder members (25) and (26) that are insulating members. The second inner cylinder member (26) has an inner-cylinder-side passage (110) forming a portion of an exhaust gas passage (100) (described below in detail).

The gas generator (35) is configured to generate high-pressure gas serving to move the blade (30) in the inner cylinder (24) to cut the harness (12). The gas generator (35) includes an explosive, an igniter (37) configured to initiate the explosive, a holder (38) configured to hold the igniter (37), and a lid member (39) configured to block the back end of the second inner cylinder member (26).

The lid member (39) is formed in a generally cylindrical configuration, and is fitted into a back end portion of the second inner cylinder member (26). The gas generation chamber (36) that is a closed space is formed behind the blade (30) by fitting the lid member (39) into the back end portion of the second inner cylinder member (26) as above. The gap between the lid member (39) and the second inner cylinder member (26) is sealed with an O ring (39c). The holder (38) is inserted through the lid member (39).

The igniter (37) is a detonator, and is held by the holder (38) such that its front end portion including a primary explosive is exposed in the gas generation chamber (36). The igniter (37) is provided with a connection pin (37a) connected to a connector (not shown). The igniter (37) generates high-pressure gas in the gas generation chamber (36) by explosion of the explosive, and increases the internal pressure of the gas generation chamber (36) to move (slide) the blade (30) forward.

The blade (30) is configured to move forward through the inner cylinder (24) under the pressure of the high-pressure gas to cut the harness (12). The blade (30) includes a cutting portion (31) made of a resin material, and a pusher (32) to which the cutting portion (31) is secured. The pusher (32) forms a pressure-receiving portion according to the present invention. The material of the cutting portion (31) is not limited to the resin material, and may be a metal material (e.g., steel).

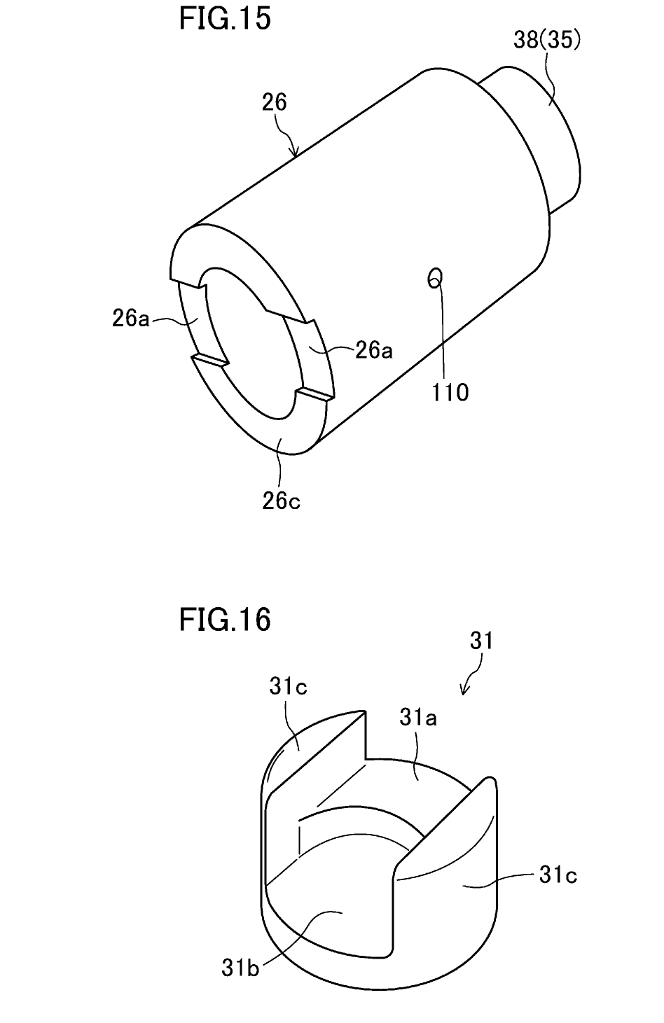

As illustrated also in FIG. 16, the cutting portion (31) includes two front and back step-like cutting portions used to cut the harness (12). Specifically, the cutting portion (31) has a first edge portion (31a) located toward the front, and a second edge portion (31b) located toward the back and having a height different from that of the first edge portion (31a). Furthermore, the cutting portion (31) includes guide portions (31c) protruding forward of the first edge portion (31a), and the guide portions (31c) slide while being in contact with the inner surface of the inner cylinder (24). The front ends of the first and second edge portions (31a) and (31b) are flat.

The difference between the height of the first edge portion (31a) and that of the second edge portion (31b) of the cutting portion (31) is larger than the thickness of each of the longitudinal plate portions (42) of the harness (12). Thus, after the first edge portion (31a) has cut a portion of the harness (12), the second edge portion (31b) can cut another portion of the harness (12). In other words, high-pressure gas moves the blade (30) forward, and thus, the first and second edge portions (31a) and (31b) sequentially cut the harness (12).

The pusher (32) is disposed behind the cutting portion (31) to move (slide) the cutting portion (31) forward under the pressure of the high-pressure gas. The pusher (32) includes a body (32a) made of a resin and having a generally cylindrical outer shape. The body (32a) is disposed such that its axis is identical with the axis of the second inner cylinder member (26). The pusher (32) has a slightly larger diameter than the cutting portion (31), and forms an insulating portion. A protrusion (32b) is formed at the front end of the body (32a) to protrude forward. The protrusion (32b) is fitted into the back end of the cutting portion (31), and thus, the cutting portion (31) is held by the pusher (32).

<Details of Structure of Exhaust Gas Passage and its Surrounding Region>

The exhaust gas passage (100) forming a release space is formed also in the blade holding member (47) of the second embodiment. The structure of the exhaust gas passage (100) and its surrounding region will be described with reference to FIGS. 9, 13, 14, and 17.

The inner-cylinder-side passage (110), a case-side passage (120), and an exhaust passage (104) are connected together to form the exhaust gas passage (100) according to the second embodiment. The inner-cylinder-side passage (110) is formed in the second inner cylinder member (26) that is a portion of the inner cylinder. The case-side passage (120) is formed in the base (13) that is a portion of the case.

The inner-cylinder-side passage (110) forms a radial passage radially passing through the second inner cylinder member (26). The inner-cylinder-side passage (110) includes an inlet hole (111) that opens through the inner circumferential surface of the second inner cylinder member (26), a diameter-increasing hole (112) the cross-sectional area of which gradually increases from an outlet of the inlet hole (111), and an outlet hole (113) that is connected to an outlet end of the diameter-increasing hole (112) and opens through the outer circumferential surface of the second inner cylinder member (26). In other words, in the inner-cylinder-side passage (110), the area of an opening of the inlet hole (111) toward the blade (30) is smaller than the cross-sectional area of the outlet hole (113). When, as such, the opening of the inlet hole (111) has a small area, this can reduce catching of the pusher (32) of the blade (30) on the edge of the opening of the inlet hole (111). This reduction allows the pusher (32) to smoothly travel, and can prevent gas leakage due to, e.g., a depression in the outer circumferential surface of the pusher (32). The outlet hole (113) and the diameter-increasing hole (112) have a larger diameter than the inlet hole (111), and thus, a process for forming each of the holes (113) and (112) is also relatively easy.

The case-side passage (120) forms a radial passage extending radially outward of the inner cylinder (24) through the resin case (20). The case-side passage (120) of this embodiment includes a groove (120a) formed in the base (13) and having a semicircular longitudinal cross section, and a groove (120b) formed in the cover (14) and having a semicircular longitudinal cross section, and the grooves (120a) and (120b) overlap each other. An outlet (120c) of the case-side passage (120) communicates with the exhaust passage (104) formed between the base (13) and the cover (14). In the second embodiment, similar to the first embodiment, an auxiliary groove passage (105) is formed in a portion of the resin case (20) opposite to the case-side passage (120) with respect to the inner cylinder (24).

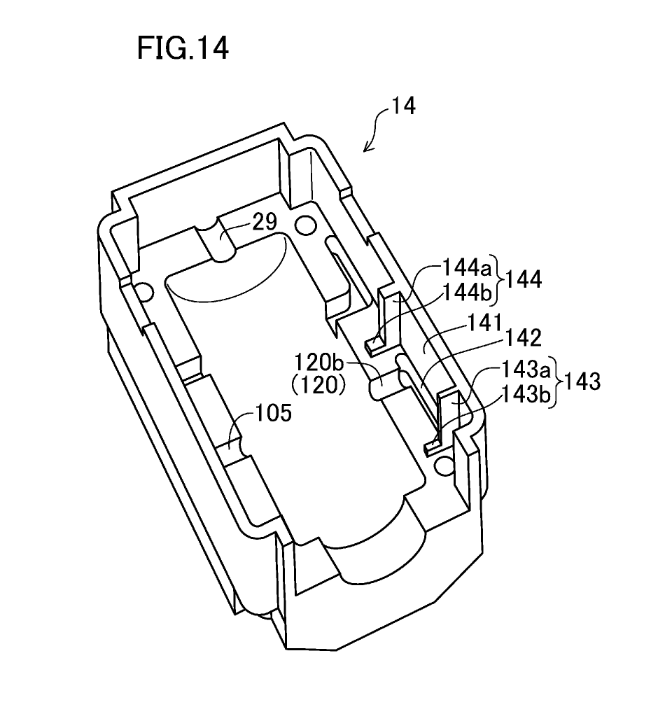

As illustrated in FIG. 14, the cover (14) of the second embodiment includes an opposite wall portion (141), a long hole (142), a first rib (143), and a second rib (144).

The opposite wall portion (141) is formed in a portion of a side wall of the cover (14) opposite to the outlet (120c) of the case-side passage (120). Specifically, the outlet (120c) of the case-side passage (120) opens toward the inner surface of the opposite wall portion (141) of the cover (14). This allows the high-pressure gas that has flowed out through the outlet (120c) to impinge on the opposite wall portion (141), thereby preventing the high-pressure gas from rapidly issuing to outside the resin case (20).

The long hole (142) is formed in an upper (lower in FIG. 14) inner surface of the cover (14) to be continuous with the groove (120b) forming a portion of the case-side passage (120) in the cover (14). The long hole (142) longitudinally extends between the first and second ribs (143) and (144). The formation of the long hole (142) as above increases the capacity of the exhaust passage (104), and can reduce the pressure of the high-pressure gas.

A back portion of the cover (14) includes the first rib (143), and a longitudinally central portion of the cover (14) includes the second rib (144). The first and second ribs (143) and (144) are generally L-shaped, and are integrally connected to the cover (14). The first and second ribs (143) and (144) each include a lateral rib (143a, 144a) formed on the side wall of the cover (14), and an upper rib (143b, 144b) formed on an upper portion of the cover (14). The first rib (143) has a smaller thickness in the longitudinal direction of the cover (14) than the second rib (144). The first and second ribs (143) and (144) form reinforcing members configured to increase the strength of the side wall (in particular, the opposite wall portion (141)) of the cover (14). This ensures adequate strength of the cover (14) against the impingement of the high-pressure gas on the opposite wall portion (141).

As illustrated in FIG. 13, an exhaust gas recess (131), a first fitting groove (132), and a second fitting groove (133) are formed in a side surface of the base (13) of the second embodiment. A portion of the base (13) corresponding to the opposite wall portion (141) of the cover (14) is recessed toward the inner cylinder (24) to form the exhaust gas recess (131). The first fitting groove (132) is formed in a back portion of the base (13) to correspond to the first rib (143). The second fitting groove (133) is formed in a longitudinally central portion of the base (13) to correspond to the second rib (144). The fitting grooves (132, 133) each include a lateral groove portion (132a, 133a) into which the lateral rib (143a, 144a) of a corresponding one of the ribs (143, 144) is fitted, and an upper groove portion (132b, 133b) into which the upper rib (143b, 144b) of the rib (143, 144) is fitted.

The cover (14) is fitted to the base (13) such that each of the ribs (143, 144) is fitted into a corresponding one of the fitting grooves (132, 133). In other words, the rib (143, 144) serves also as a positioning member configured to determine the relative location of the cover (14) and the base (13).

The second rib (144) of the cover (14) is fitted into the second fitting groove (133) of the base (13) to form a protrusion/depression in the gap between the cover (14) and the base (13), and thus, the gap can be sealed. Specifically, when, during the cutting of the harness (12), high-pressure gas that has flowed out of the case-side passage (120) flows through the gap between the cover (14) and the base (13) toward the harness (12), electrical insulation between portions into which the harness (12) has been cut is impaired as described above. However, as such, the second rib (144) is fitted into the second fitting groove (133) to form a sealing surface therebetween, thereby preventing the leakage of such high-pressure gas. In other words, the second rib (144) and the second fitting groove (133) serve also as a sealing portion configured to prevent the leakage of the high-pressure gas toward the harness (12).

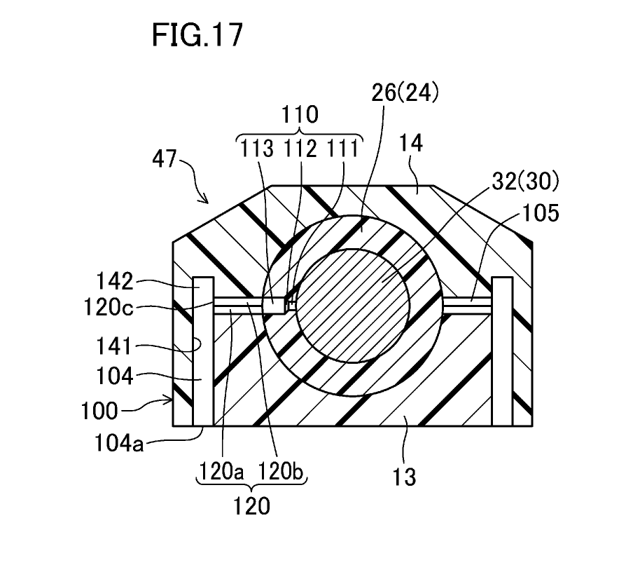

As illustrated also in FIG. 17, when the cover (14) is fitted to the base (13), the exhaust passage (104) is formed between the exhaust gas recess (131) and the opposite wall portion (141). Similar to the first embodiment, the exhaust passage (104) extends vertically downward along the base (13), and its outlet end (104a) opens through the lower surface of the base (13).

—Discharge Operation of High-Pressure Gas—

When the cutter (10) of the second embodiment is cutting the harness (12), explosion of the explosive allows the generation of high-pressure gas in the gas generation chamber (36).

Before the explosion of the explosive in the gas generation chamber (36), the blade (30) is located toward the back as illustrated in FIG. 9. In this situation, the inner-cylinder-side passage (110) of the exhaust gas passage (100) is disconnected from the back pressure chamber (49). Therefore, in this situation, the high-pressure gas in the back pressure chamber (49) does not flow into the exhaust gas passage (100). This can ensure an increase in the pressure of the back pressure chamber (49) to move the blade (30) forward.

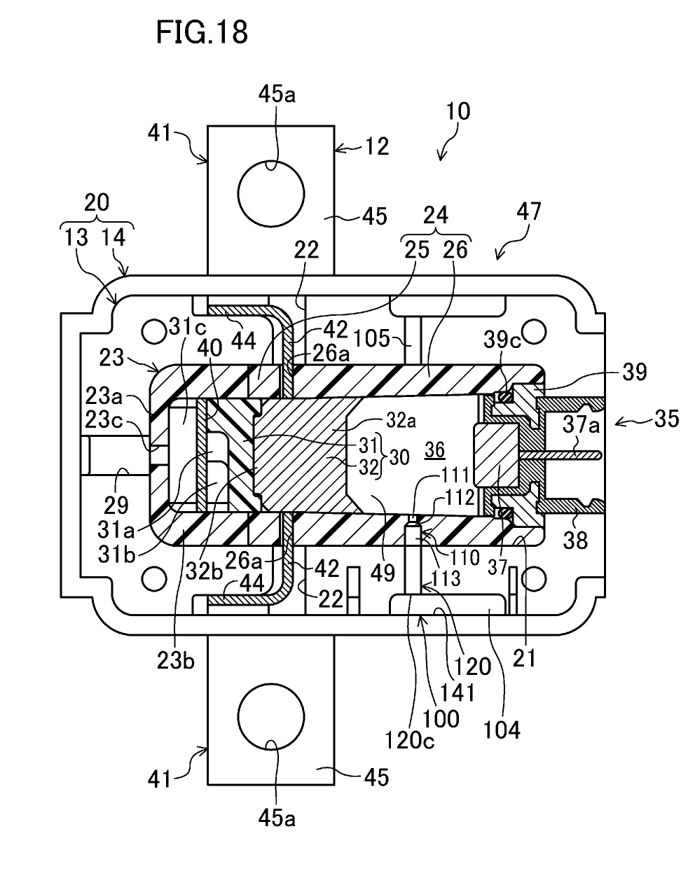

When, as such, the blade (30) moves forward, and cuts the harness (12), the back pressure chamber (49) and the inner-cylinder-side passage (110) communicate with each other (see, e.g., FIG. 18). Then, the high-pressure gas in the back pressure chamber (49) flows through the inner-cylinder-side passage (110) and the case-side passage (120) in sequential order, flows out through the outlet (120c), and impinges on the opposite wall portion (141) of the cover (14). The high-pressure gas that has impinged on the opposite wall portion (141) flows downward through the exhaust passage (104) along the surface of the opposite wall portion (141). The high-pressure gas is discharged through the outlet end (106) to outside the blade holding member (47).

As described above, also in the second embodiment, after the target portion (40) of the harness (12) has been cut, the high-pressure gas in the back pressure chamber (49) is discharged through the exhaust gas passage (100) to outside the blade holding member (47). This can prevent the high-pressure gas in the back pressure chamber (49) from leaking through the gap between the blade (30) and the inner cylinder (24) toward portions into which the harness (12) has been divided. This can ensure electrical insulation between the portions of the harness (12), and can ensure the reliability of the cutter (10).

### Variations of Second Embodiment

In the above-described embodiment, the following variations may be provided.

<First Variation>

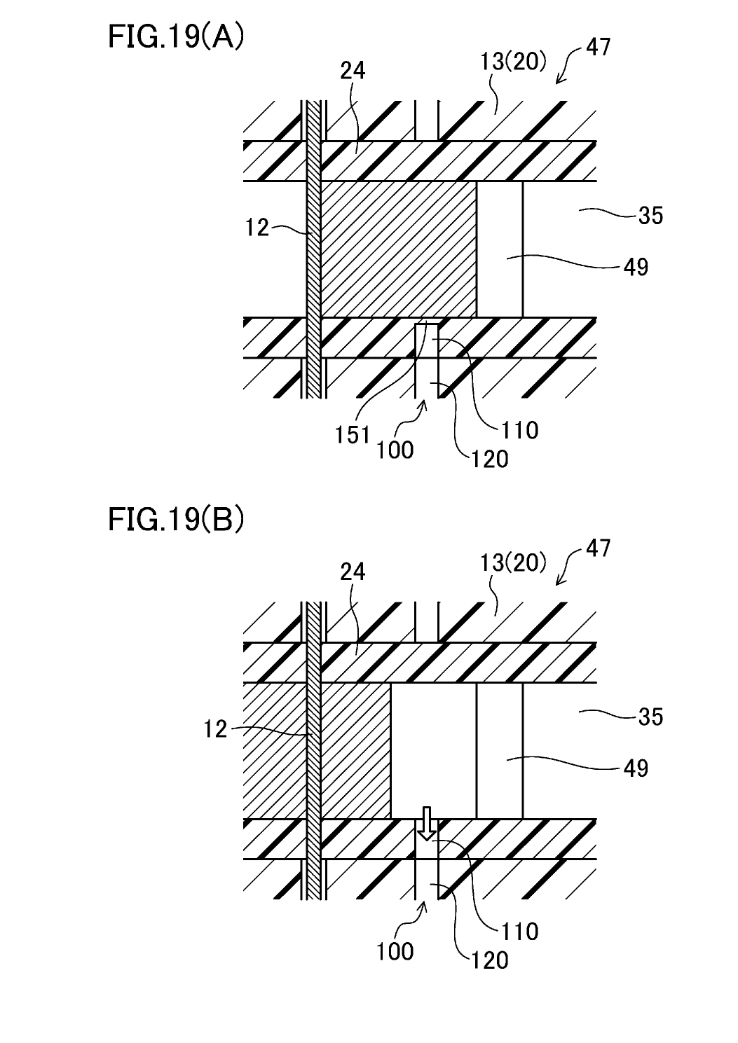

As schematically illustrated in FIG. 19(A), in a cutter (10) of a first variation, a thin wall (151) is formed at an inlet end of an exhaust gas passage (100). The thin wall (151) is a thin film made of a resin and integrally connected to an inner cylinder (24) by, e.g., injection molding. The thin wall (151) blocks the inlet end of the exhaust gas passage (100) before a blade (30) cuts a harness (12) (i.e., in the situation illustrated in FIG. 19(A)), and forms a portion of the inner circumferential wall surface of the inner cylinder (24). If an opening is to be formed at the inlet end of the exhaust gas passage (100) by injection molding, burrs may be formed around the opening, and thus, such burrs need to be handled. However, when the thin wall (151) is integrally formed as illustrated in FIG. 19(A), this eliminates the need for handling such burrs, and quality control and fabrication process can be simplified.

In the first variation, when a gas generator (35) generates high-pressure gas to move the blade (30), the thin wall (151) is in sliding contact with the outer circumferential surface of a pusher (32). In other words, the thin wall (151) of the first variation functions as a guide surface on which the pusher (32) is guided, and thus, the outer circumferential surface of the pusher (32) is not caught on the edge of an inlet of the exhaust gas passage (100). This allows the blade (30) to smoothly travel, and can ensure the prevention of gas leakage due to, e.g., a depression in the outer circumferential surface of the pusher (32).

When the blade (30) further travels, and the pressure of a back pressure chamber (49) increases, the pressure allows a break in the thin wall (151). In other words, the material and thickness of the thin wall (151) are determined such that the thin wall (151) is weak enough to be broken due to the high-pressure gas generated by the gas generator (35). When the thin wall (151) is broken as illustrated in FIG. 19(B), the high-pressure gas in the back pressure chamber (49) flows into the exhaust gas passage (100), and is discharged to outside the blade holding member (47) as described above. This prevents the high-pressure gas in the back pressure chamber (49) from leaking toward the harness (12).

<Second Variation>

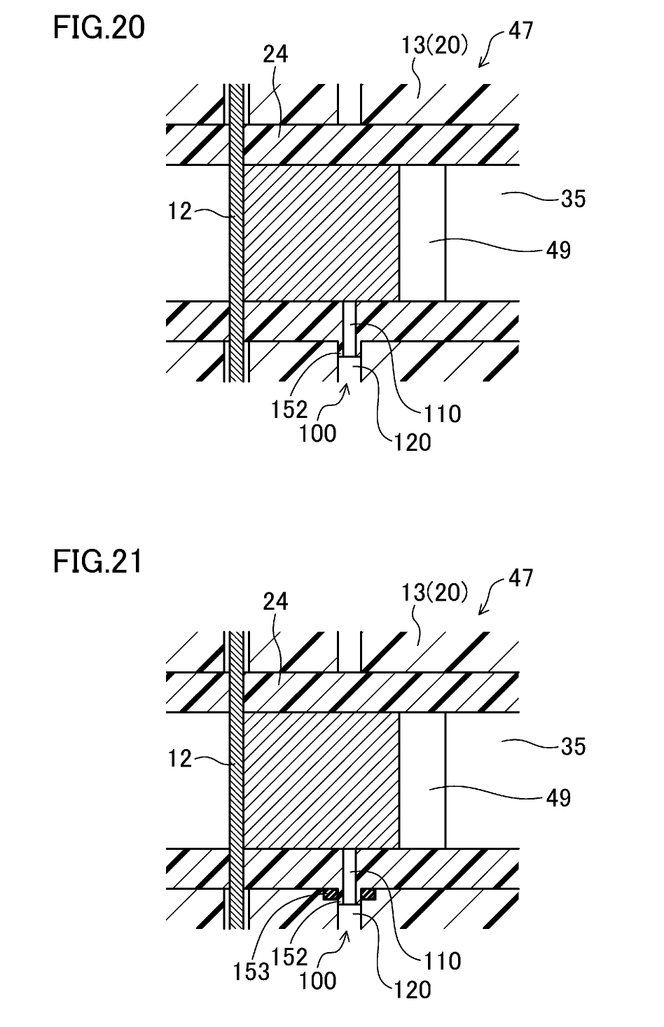

As schematically illustrated in FIG. 20, in a cutter (10) of a second variation, a circular cylindrical protrusion (152) is formed on the outer circumferential surface of an inner cylinder (24). The protrusion (152) protrudes radially outward from the inner cylinder (24), and is fitted into an inlet end of a case-side passage (120). The protrusion (152) functions as a sealing portion configured to prevent high-pressure gas that has flowed out of an inner-cylinder-side passage (110) from leaking through the gap between the inner cylinder (24) and a resin case (20) toward portions into which the harness (12) has been cut. This can further ensure electrical insulation between the portions of the harness (12).

<Third Variation>

As schematically illustrated in FIG. 21, in a cutter (10) of a third variation, an annular small-diameter O ring (153) is fitted onto the outer circumferential surface of the protrusion (152) of the second variation. In other words, in the third variation, the protrusion (152) and the small-diameter O ring (153) function as a sealing portion configured to prevent high-pressure gas from leaking through the gap between the inner cylinder (24) and a resin case (20) toward portions into which the harness (12) has been cut. The protrusion (152) of the third variation may be omitted, and only the small-diameter O ring (153) may be provided around an outlet of the inner-cylinder-side passage (110).

<Fourth Variation>

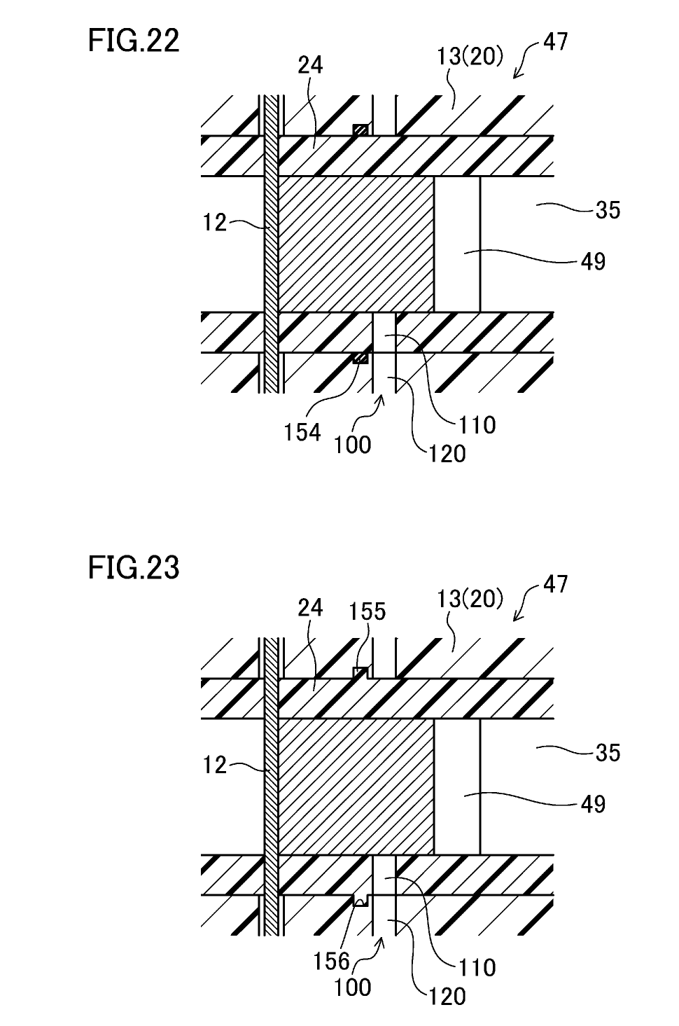

As schematically illustrated in FIG. 22, in a cutter (10) of a fourth variation, a large-diameter O ring (154) is provided on the outer circumferential surface of an inner cylinder (24). The large-diameter O ring (154) is provided in the vicinity of an outlet of an inner-cylinder-side passage (110) and toward a harness (12). In the fourth variation, the large-diameter O ring (154) functions as a sealing portion configured to prevent high-pressure gas from leaking through the gap between the inner cylinder (24) and a resin case (20) toward portions into which the harness (12) has been cut.

<Fifth Variation>

As schematically illustrated in FIG. 23, instead of the large-diameter O ring (154) of the fourth variation, an annular protrusion (155) may be formed on the outer circumferential surface of an inner cylinder (24). The annular protrusion (155) may be fitted into an annular recess (156) formed in the inner circumferential surface of a resin case (20) to form a sealing portion between the inner cylinder (24) and the resin case (20).

### Third Embodiment of the Invention

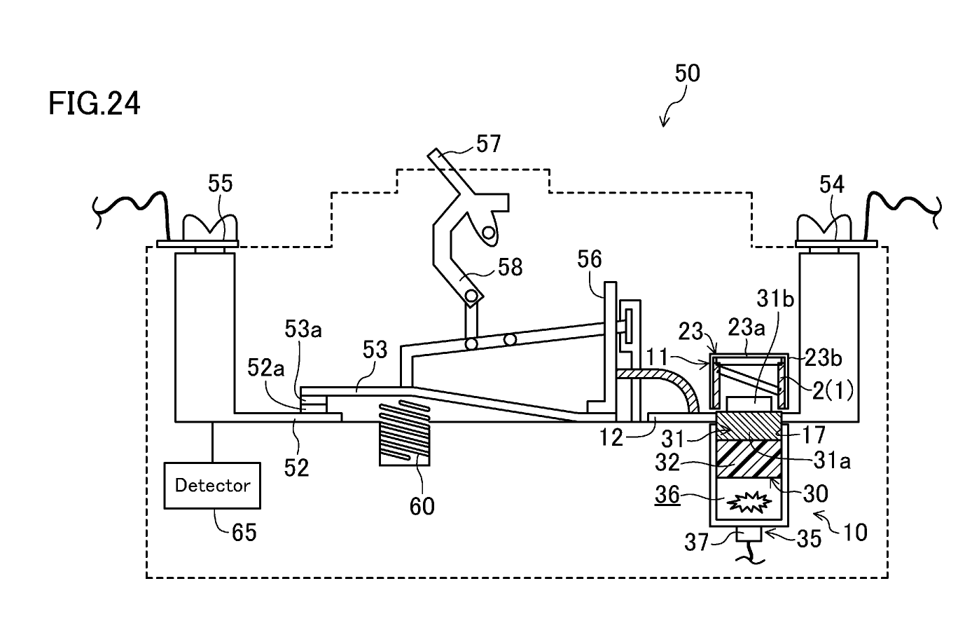

Next, a third embodiment will be described. As illustrated in FIG. 24, the third embodiment is directed to a breaker (50) including a cutter (10) according to the present invention. The breaker (50) includes a load terminal (55) and a line terminal (54) fitted to a casing made of a resin (not shown), and a terminal-to-terminal connection member that is a harness (12) and is configured to connect the load terminal (55) and the line terminal (54) together.

The terminal-to-terminal connection member includes a stationary contact (52) connected to the load terminal (55), and a movable contact (53) connected to the line terminal (54). The movable contact (53) can be moved between the contact location at which the movable contact (53) is in contact with the stationary contact (52) and a noncontact location at which the movable contact (53) is apart from the stationary contact (52). When the movable contact (53) moves to the contact location, a movable contact point (53a) of the movable contact (53) is in contact with a stationary contact point (52a) of the stationary contact (52).

Furthermore, the breaker (50) includes a linkage (58) configured to manually move the movable contact (53), a trip mechanism (56) configured to separate the movable contact (53) from the stationary contact (52) in the event of abnormal current conditions, and a bias spring (60) configured to bias the movable contact (53) to separate the movable contact (53) from the stationary contact (52). The linkage (58) is mounted to the casing such that the movable contact (53) can be moved between the contact location and the noncontact location by operation of a manual lever (57). The trip mechanism (56) is made of bimetal, and provides connection between the movable contact (53) and the line terminal (54). The trip mechanism (56) is thermally deformed in the event of overcurrent conditions (abnormal current conditions), and the thermal deformation allows the linkage (58) to move, thereby separating the movable contact (53) from the stationary contact (52). When the movable contact (53) is separated from the stationary contact (52), the breaker (50) cannot be energized.

Furthermore, the breaker (50) includes the above-described cutter (10), and a weld detector (65) configured to detect the completion of welding between the movable contact point (53a) and the stationary contact point (52a). Any one of the cutters (10) of the first and second embodiments and the other embodiments described below may be used as the cutter (10) of this embodiment.

The cutter (10) is located so as to be able to cut the terminal-to-terminal connection member. Specifically, the cutter (10) is located on the back surface of the terminal-to-terminal connection member (the lower surface in FIG. 24).

The weld detector (65) is connected to, e.g., the terminal-to-terminal connection member to detect whether or not the movable contact point (53a) and the stationary contact point (52a) have been welded together based on the current value through the terminal-to-terminal connection member. An igniter (37) of the cutter (10) is connected to the weld detector (65). When the weld detector (65) determines that the movable contact point (53a) and the stationary contact point (52a) have been welded together, the weld detector (65) actuates the igniter (37).

In the third embodiment, when the weld detector (65) determines that the movable contact point (53a) and the stationary contact point (52a) have been welded together, the igniter (37) is actuated to explode an explosive, and the blade (30) travels. The blade (30) cuts (breaks) the terminal-to-terminal connection member, and then, the pusher (32) stops while being in contact with the cut surfaces of the terminal-to-terminal connection member. This allows electrical insulation between the cut surfaces of the terminal-to-terminal connection member, thereby disabling the passage of current between the line terminal (54) and the load terminal (55).

### Advantages of Third Embodiment

In the third embodiment, the cutter (10) can forcibly disable the passage of current between the line terminal (54) and the load terminal (55). Thus, for example, even when the movable contact (53) and the stationary contact (52) have been welded together, the cutter (10) can forcibly disable the passage of current between the line terminal (54) and the load terminal (55) to prevent a breakdown of a load-side device.

### Fourth Embodiment of the Invention

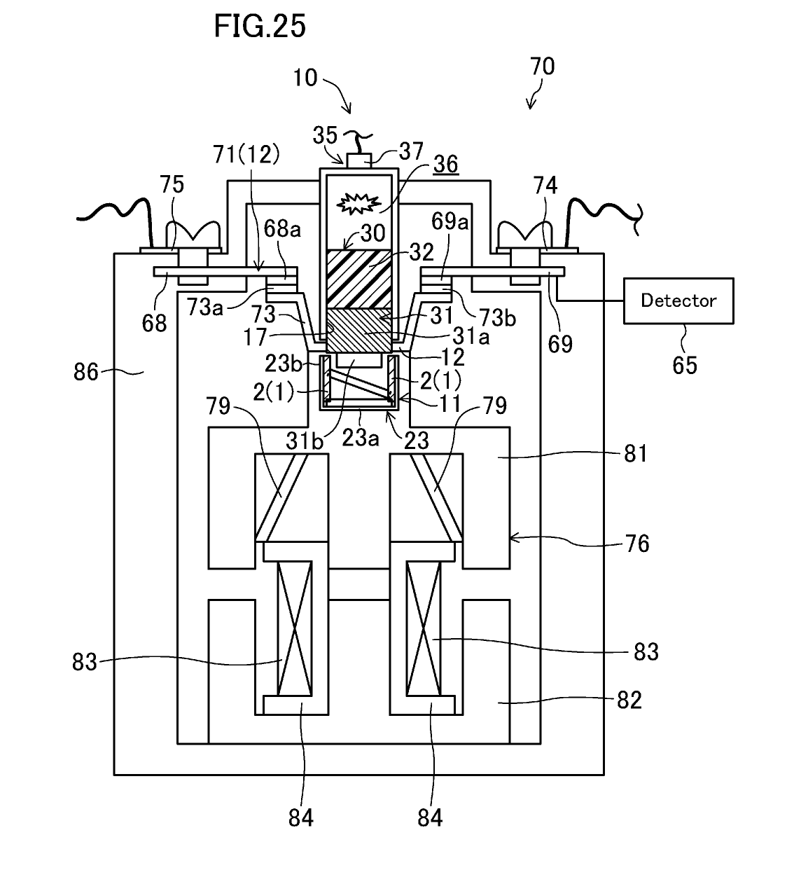

Next, a fourth embodiment will be described. As illustrated in FIG. 25, the fourth embodiment is directed to a contactor including a cutter (10) according to the present invention. As illustrated in FIG. 25, the contactor (70) includes a load terminal (75) and a line terminal (74) fitted to a casing (86) made of a resin, and a terminal-to-terminal connection member (71) that is a harness (12) and is configured to connect the load terminal (75) and the line terminal (74) together.

The terminal-to-terminal connection member (71) includes a first stationary contact (68) connected to the load terminal (75), and a second stationary contact (69) connected to the line terminal (74), and a movable contact (73) coupled to a movable core (81) described below. The movable contact (73) can be moved between the contact location at which the movable contact (73) is in contact with a pair of the stationary contacts (68, 69) and a noncontact location at which the movable contact (73) is apart from the pair of the stationary contacts (68, 69). When the movable contact (73) moves to the contact location, a movable contact point (73a) of the movable contact (73) at one end thereof is in contact with a first stationary contact point (68a) of the first stationary contact (68), and a movable contact point (73b) of the movable contact (73) at the other end thereof is in contact with a second stationary contact point (69a) of the second stationary contact (69).

Furthermore, the contactor (70) includes a transfer mechanism (76) configured to transfer the movable contact (73) between the contact location and the noncontact location. The transfer mechanism (76) includes the movable core (81), a stationary core (82), an exciting coil (83), and a spool (84). The stationary core (82) is fixed on the bottom surface of the casing (86). The movable core (81) faces an upper surface of the stationary core (82). The exciting coil (83) is wound around the spool (84). A pair of return springs (79) are provided between the movable core (81) and the spool (84) to separate the movable core (81) from the stationary core (82) when the contactor (70) is in a non-energized condition.

The transfer mechanism (76) is configured such that when the exciting coil (83) is energized by an external signal, the stationary core (82) is excited to attract the movable core (81). When the movable core (81) is attracted by the stationary core (82), the contactor (70) is in a non-energized condition. By contrast, the transfer mechanism (76) is configured such that when the energization of the exciting coil (83) is stopped by an external signal, the return springs (79) separate the movable core (81) from the stationary core (82). The separation of the movable core (81) from the stationary core (82) allows the contactor (70) to be in an energized condition.

Furthermore, the contactor (70) includes the above-described cutter (10), and a weld detector (65) having a configuration similar to that of the third embodiment. Any one of the cutters (10) of the first and second embodiments and the other embodiments described below may be used as the cutter (10) of this embodiment.

The cutter (10) is located so as to be able to cut the terminal-to-terminal connection member (71). Specifically, the cutter (10) is disposed such that a cutting portion (31) of a blade (30) that has not yet travelled faces a front surface of the movable contact (73).

In the fourth embodiment, when the weld detector (65) determines that the movable contact points (73a 73b) each have been welded to a corresponding one of the stationary contact points (68a, 69a), the igniter (37) is actuated to explode an explosive, and the blade (30) travels. The blade (30) cuts (breaks) the movable contact (73). In this situation, a pusher (32) is in contact with the cut surfaces of the movable contact (73). In other words, the blade (30) travels until the pusher (32) is in contact with the cut surfaces of the movable contact (73).

### Advantages of Fourth Embodiment

In the fourth embodiment, the cutter (10) can forcibly disable the passage of current between the line terminal (74) and the load terminal (75). Thus, for example, even when the movable contact (73) and the stationary contacts (68, 69) have been welded together, the cutter (10) can forcibly disable the passage of current between the line terminal (74) and the load terminal (75) to prevent a breakdown of a load-side device.

### Fifth Embodiment of the Invention

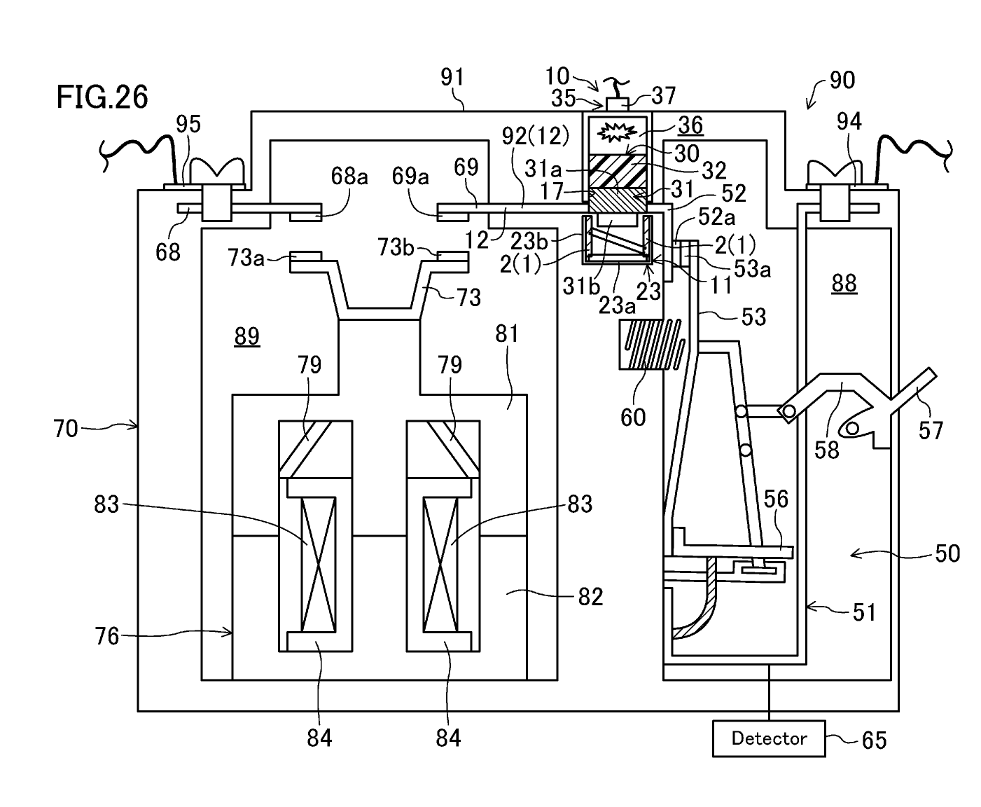

Next, a fifth embodiment will be described. As illustrated in FIG. 26, the fifth embodiment is directed to an electric circuit breaker (90) including a cutter (10) according to the present invention. The electric circuit breaker (90) includes a breaker (50), a contactor (70), and a casing (91) made of a resin. A description of each of the breaker (50) and the contactor (70) is not given.

A breaker placement chamber (88) in which the breaker (50) is placed, and a contactor placement chamber (89) in which the contactor (70) is placed are formed in the casing (91) with a barrier interposed therebetween. The casing (91) includes a load terminal (95), a line terminal (94), and a connection member (92) providing connection between the breaker (50) and the contactor (70). The connection member (92) is a harness (12).

The load terminal (95) is connected to a first stationary contact (68) of the contactor (70). The line terminal (94) is connected to a movable contact (53) of the breaker (50). Furthermore, one end of the connection member (92) is connected to a second stationary contact (69) of the contactor (70). The other end of the connection member (92) is connected to a stationary contact (52) of the breaker (50).

Moreover, the electric circuit breaker (90) includes the above-described cutter (10), and a weld detector (65) similar to that of the second embodiment. Any one of the cutters (10) of the first and second embodiments and the other embodiments described below may be used as the cutter (10) of this embodiment.

The cutter (10) is located so as to be able to cut the connection member (92). Specifically, the cutter (10) is disposed such that a cutting portion (31) of a blade (30) that has not yet travelled faces a front surface of the connection member (92).

In the fifth embodiment, when the weld detector (65) determines that in the breaker (50), the movable contact (53) and the stationary contact (52) have been welded together, or when the weld detector (65) determines that in the contactor (70), the movable contact (73) and the stationary contacts (68, 69) have been welded together, the weld detector (65) actuates the igniter (37), and the blade (30) travels to cut (break) the connection member (92). In this situation, a pusher (32) is in contact with the cut surfaces of the connection member (92). In other words, the blade (30) travels until the pusher (32) is in contact with the cut surfaces of the connection member (92).

### Advantages of Fifth Embodiment

In the fifth embodiment, the cutter (10) cuts the connection member (92), thereby disabling the passage of current between the line terminal (94) and the load terminal (95). Thus, for example, even when, in the breaker (50) or the contactor (70), contacts have been welded together, the cutter (10) can disable the passage of current between the line terminal (94) and the load terminal (95) to prevent a breakdown of a load-side device.

### Other Embodiments

The configuration of the above-described exhaust gas passage (100) is merely an example. As long as the exhaust gas passage (100) is disconnected from the back pressure chamber (49) before the blade (30) cuts the harness (12), and communicates with the back pressure chamber (49) after the blade (30) has cut the harness (12), the exhaust gas passage (100) may be formed at another location, and may have another shape.

The above-described exhaust gas passage (100) communicates with the back pressure chamber (49) after the blade (30) has cut the harness (12). However, the exhaust gas passage (100) may communicate with the back pressure chamber (49) immediately before the blade (30) cuts the harness (12). For example, when the cross-sectional area of the exhaust gas passage (100) is reduced to increase the resistance of the passage, or when the power of high-pressure gas generated by the gas generator (35) is increased, this can ensure the internal pressure of the back pressure chamber (49) to some extent in a period after the exhaust gas passage (100) has communicated with the back pressure chamber (49) and before the blade (30) cuts the harness (12), and thus, the harness (12) can be cut.

The outlet end of the exhaust gas passage (100) does not always need to be open to outside the blade holding member (47). Also in this configuration, when the back pressure chamber (49) and the exhaust gas passage (100) are brought into communication with each other after the harness has been cut, this can reduce the pressure of the back pressure chamber (49). This can avoid the leakage of the high-pressure gas to the target portion (40).

In the above embodiments, a sheet metal is bent to form the harness (12). However, the shape of the harness (12) is not limited to the above-described shape, and, for example, a bar-like harness (12) can be used.

In the above embodiments, a sealing portion between the inner cylinder (24) and the resin case (20), or a sealing portion (133, 144) between the base (13) and the cover (14) may be formed by filling the gap between the inner cylinder (24) and the resin case (20) or between the base (13) and the cover (14) with a sealant made of, e.g., a silicone resin. This can also prevent high-pressure gas from leaking through the gap, and can also ensure electrical insulation between portions into which the harness (12) has been cut.

The above embodiments are set forth merely for the purposes of preferred examples in nature, and are not intended to limit the scope, applications, and use of the invention.

### INDUSTRIAL APPLICABILITY

As described above, the present invention is useful for cutters.

### DESCRIPTION OF REFERENCE CHARACTERS

10 Cutter
12 Harness (Current-Carrying Member)
13 Base (Holding Portion)
14 Cover
20 Resin Case (Case)
24 Inner Cylinder
30 Blade (Blade Member)
35 Gas Generator
40 Target Portion
41 Conductive Portion
47 Blade Holding Member (Holding Member)
48 Opening (Exposure Opening)
49 Back Pressure Chamber
100 Exhaust Gas Passage (Release Space)
102 Communicating Path (Radial Passage)
103 Groove Passage (Radial Passage)
103a Gas Outlet
110 Inner-Cylinder-Side Passage (Radial Passage)
120 Case-Side Passage (Radial Passage)
133 Second Fitting Groove (Sealing Portion)
144 Second Rib (Sealing Portion)
151 Thin Wall
152 Protrusion (Sealing Portion)
153 Small-Diameter O Ring (Sealing Portion)
154 Large-Diameter O Ring (Sealing Portion)

1. A cutter comprising:
a blade member configured to cut a target portion of a current-carrying member;
a holding member formed in a cylindrical configuration to accommodate the blade member such that the blade member is movable, having one axial end having an opening exposing the target portion, and the other axial end at which a back pressure chamber is defined to face the blade member; and
a gas generator configured to generate high-pressure gas used to move the blade member toward the target portion in the back pressure chamber, wherein
a release space is formed in the holding member so as to be disconnected from the back pressure chamber before the blade member cuts the current-carrying member, and communicate with the back pressure chamber after the blade member has cut the current-carrying member.

2. The cutter of claim 1, wherein
the release space forms an exhaust gas passage through which after the blade member has cut the current-carrying member, the back pressure chamber communicates with a space outside the holding member.

3. The cutter of claim 1, wherein
the release space is formed in a portion of the holding member located on an outer circumferential surface of the blade member.

4. The cutter of claim 3, wherein
the release space includes at least one radial passage radially extending through the portion of the holding member located on the outer circumferential surface of the blade member.

5. The cutter of claim 1, wherein
a thin wall is formed at an inlet end of the release space, and before the blade member cuts the current-carrying member, the thin wall blocks the release space to form an inner circumferential surface of the holding member, and is broken by high-pressure gas generated by the gas generator.

6. The cutter of claim 1, wherein
the holding member includes an inner cylinder movably accommodating the blade member, and a case accommodating the inner cylinder and the current-carrying member,
the release space includes an inner-cylinder-side passage formed in the inner cylinder, and having an outlet end that opens through an outer circumferential surface of the inner cylinder, and a case-side passage formed in the case to communicate with the outlet end of the inner-cylinder-side passage, and
a sealing portion is formed between the inner cylinder and the case to prevent gas that has flowed out of the inner-cylinder-side passage from flowing to the cut current-carrying member.

7. The cutter of claim 1, wherein
the holding member includes an inner cylinder accommodating the blade member such that the blade member is movable, a holding portion accommodating the inner cylinder and the current-carrying member, and a cover covering the holding portion, and
the release space includes an inner-cylinder-side passage formed in the inner cylinder, and a case-side passage formed in the holding portion to communicate with an outlet end of the inner-cylinder-side passage, and having an outlet end that opens toward a wall surface of the cover.

8. The cutter of claim 7, wherein
a sealing portion is formed between the holding portion and the cover to prevent gas that has flowed out of the case-side passage from flowing to the cut current-carrying member.

9. The cutter of claim 1, wherein
the release space includes a gas outlet that opens toward a conductive portion of the current-carrying member different from the target portion.

10. The cutter of claim 1, wherein
the current-carrying member has a pair of conductive portions that are located laterally outward of the target portion and into which the current-carrying member is divided by cutting the target portion away with the blade member, and
the release space is formed in a portion of the holding member near one of the pair of the conductive portions.

11. The cutter of claim 2, wherein
the release space is formed in a portion of the holding member located on an outer circumferential surface of the blade member.

12. The cutter of claim 11, wherein
the release space includes at least one radial passage radially extending through the portion of the holding member located on the outer circumferential surface of the blade member.

13. The cutter of claim 2, wherein
a thin wall is formed at an inlet end of the release space, and before the blade member cuts the current-carrying member, the thin wall blocks the release space to form an inner circumferential surface of the holding member, and is broken by high-pressure gas generated by the gas generator.

14. The cutter of claim 2, wherein
the holding member includes an inner cylinder movably accommodating the blade member, and a case accommodating the inner cylinder and the current-carrying member,
the release space includes an inner-cylinder-side passage formed in the inner cylinder, and having an outlet end that opens through an outer circumferential surface of the inner cylinder, and a case-side passage formed in the case to communicate with the outlet end of the inner-cylinder-side passage, and
a sealing portion is formed between the inner cylinder and the case to prevent gas that has flowed out of the inner-cylinder-side passage from flowing to the cut current-carrying member.

15. The cutter of claim 2, wherein
the holding member includes an inner cylinder accommodating the blade member such that the blade member is movable, a holding portion accommodating the inner cylinder and the current-carrying member, and a cover covering the holding portion, and
the release space includes an inner-cylinder-side passage formed in the inner cylinder, and a case-side passage formed in the holding portion to communicate with an outlet end of the inner-cylinder-side passage, and having an outlet end that opens toward a wall surface of the cover.

16. The cutter of claim 2, wherein
the release space includes a gas outlet that opens toward a conductive portion of the current-carrying member different from the target portion.

17. The cutter of claim 2, wherein
the current-carrying member has a pair of conductive portions that are located laterally outward of the target portion and into which the current-carrying member is divided by cutting the target portion away with the blade member, and
the release space is formed in a portion of the holding member near one of the pair of the conductive portions.

18. The cutter of claim 3, wherein
a thin wall is formed at an inlet end of the release space, and before the blade member cuts the current-carrying member, the thin wall blocks the release space to form an inner circumferential surface of the holding member, and is broken by high-pressure gas generated by the gas generator.

19. The cutter of claim 3, wherein
the holding member includes an inner cylinder movably accommodating the blade member, and a case accommodating the inner cylinder and the current-carrying member,
the release space includes an inner-cylinder-side passage formed in the inner cylinder, and having an outlet end that opens through an outer circumferential surface of the inner cylinder, and a case-side passage formed in the case to communicate with the outlet end of the inner-cylinder-side passage, and
a sealing portion is farmed between the inner cylinder and the case to prevent gas that has flowed out of the inner-cylinder-side passage from flowing to the cut current-carrying member.

20. The cutter of claim 3, wherein
the current-carrying member has a pair of conductive portions that are located laterally outward of the target portion and into which the current-carrying member is divided by cutting the target portion away with the blade member, and
the release space is formed in a portion of the holding member near one of the pair of the conductive portions.
